(19) United States
(12) Patent Application Publication
(10) Pub. No.: US 2012/0313865 A1
(43) Pub. Date: Dec. 13, 2012

(54) INTERACTIVE SURFACE WITH A PLURALITY OF INPUT DETECTION TECHNOLOGIES

(75) Inventor: Nigel Pearce, Lancashire (GB)

(73) Assignee: PROMETHEAN LTD, Lancashire (GB)

(21) Appl. No.: 13/392,437

(22) PCT Filed: Aug. 25, 2009
(86) PCT No.: PCT/EP2009/060944

§ 371 Date: Aug. 6, 2012

(51) Int. Cl. G06F 3/041

(52) U.S. Cl. 345/173

(57) ABSTRACT

There is disclosed an interactive display system including a display surface, a first means for detecting a first type of user input at the display surface and a second means for detecting a second type of user input at the display surface, wherein at least one portion of the display surface is adapted to be selectively responsive to an input of a specific type.

### BACKGROUND TO THE INVENTION

1. Field of the Invention

The present invention relates to an interactive display system including an interactive surface, which interactive surface is adapted to detect inputs of more than one type, such interactive surface provided with more than one type of input detection technology.

2. Description of the Related Art

A typical example of an interactive display system is an electronic whiteboard system. An electronic whiteboard system typically is adapted to sense the position of a pointing device or pointer relative to a working surface (the display surface) of the whiteboard, the working surface being an interactive surface. When an image is displayed on the work surface of the whiteboard, and its position calibrated, the pointer can be used in the same way as a computer mouse to manipulate objects on the display by moving the pointer over the surface of the whiteboard.

A typical application of an interactive whiteboard system is in a teaching environment. The use of interactive whiteboards improves teaching productivity and also improves student comprehension. Such whiteboards also allow use to be made of good quality digital teaching materials, and allow data to be manipulated and presented using audio visual technologies.

A typical construction of an electronic whiteboard system comprises an interactive display surface forming the electronic whiteboard, a projector for projecting images onto the display surface, and a computer system in communication with the interactive display surface for inputs detected at the interactive surface and for generating the images for projection, running software applications associated with such images, and for processing data received from the interactive display surface associated with pointer activity at the interactive display surface, such as the coordinate location of the pointer on the display surface. In this way the computer system can control the generation of images to take into account the detected movement of the pointer on the interactive display surface.

Interactive surfaces of interactive display systems typically offer methods of human-computer interaction which are traditionally facilitated by the use of a single input technology type in an interactive surface. Examples of single input technology types include, but are not limited to, electromagnetic pen sensing, resistive touch sensing, capacitive touch sensing, and optical sensing technologies.

More recently, interactive surfaces have emerged that offer the ability to process multiple and simultaneous inputs, by detecting two or more independent inputs directly on the interactive surface. A single input technology type of an interactive surface streams the inputs from the multiple simultaneous contact points to the associated computer system. Application functionality is offered in such systems which takes advantage of these multiple input streams. For example, application functionality is offered in which combinations of multiple simultaneous contact points are used in order to invoke a predefined computer function. A specific example of this is in a known touch-sensitive interactive display surface, where two simultaneous points of touch (for example two finger points) upon the same displayed image can be used to manipulate the image, for example rotating the image by altering the angle between the two points of contact.

It is also known in the art to combine two disparate and independent input technology types within a single interactive surface in an interactive display system. Reference can be made to U.S. Pat. No. 5,402,151 which discloses an interactive display system including an interactive display surface, formed by a touch screen and a digitising tablet (or electromagnetic grid) integrated with each other, which are activated independently of each other by an appropriate stimuli. The touch screen and the digitising tablet each comprise a respective input technology type, or input sensing means, to detect the respective stimuli, namely either_a touch input or a pen (electromagnetic) input. Thus there is known an interactive display system which facilitates human-computer interaction by the use of a plurality of input technology types in an interactive display surface. In such system the interactive display surface is adapted such that one of the input technology types is enabled at any time.

It is an aim of the invention to provide improvements in an interactive display system incorporating two or more disparate and independent input detection technologies in an interactive surface.

### SUMMARY OF THE INVENTION

In one aspect there is provided an interactive display system including a display surface, a first means for detecting a first type of user input at the display surface and a second means for detecting a second type of user input at the display surface, wherein at least one portion of the display surface is adapted to be selectively responsive to an input of a specific type.

The at least one portion of the display surface may be a physical area of the display surface. The at least one portion of the display surface may be a plurality of physical areas of the display surface. The at least one portion of the display surface may be at least one object displayed on the display surface. The at least one portion of the display surface may be a plurality of objects displayed on the display surface. The at least one portion may be a part of at least one displayed object. The part of the displayed object may be at least one of a centre of an object, an edge of an object, or all the edges of an object.

The at least one portion of the display surface is a window of an application running on the interactive display system. The at least one portion of the display surface may be a plurality of windows of a respective plurality of applications running on the interactive display system. The at least one portion is a part of a displayed window of at least one displayed application.

The at least one portion of the display surface may be adapted to be selectively responsive to at least one of: i) a first type of user input only; ii) a second type of user input only; iii) a first type of user input or a second type of user input; iv) a first type of user input and a second type of user input; v) a first type of user input then a second type of user input; vi) a second type of user input then a first type of user input; or vii) no type of user input.

The at least one portion of the display surface may be adapted to be responsive to an input of a specific type further in dependence upon identification of a specific user. The user may be identified by the interactive display system in dependence on a user log-in.

The at least one portion of the display surface may be dynamically adapted to be responsive to an input of a specific type.

The at least one portion of the display surface may be variably adapted to be responsive to an input of a specific type over time.

The invention provides an interactive display system including an interactive display surface, the interactive display surface being adapted to detect inputs at the surface using a first input detection technology and a second input detection technology, wherein there is defined at least one input property for the interactive display surface which determines whether an input at the interactive surface is detected using one, both or neither of the first and second input detection technologies.

There may be defined a plurality of input properties, each associated with an input condition at the interactive surface.

An input condition may be defined by one or more of: a physical location on the interactive surface; an object displayed on the interactive surface; an application displayed on the interactive surface; an identity of a pointing device providing an input; or an identity of a user providing an input.

The type of user input may determine an action responsive to a user input. The action may be applied to an object at the location of the user input. The action may be further dependent upon a system input. The system input may be a mouse input, keyboard input, or graphics tablet input. At least one of the types of user input may be an identifiable input device. The action may be dependent upon the identity of the identifiable input device providing the user input. The action may be dependent upon the identity of a user associated with an input. The action may be responsive to a user input of a first type and a user input of a second type. The action may be applied to an object, and comprises one of the actions: move, rotate, scribble or cut. In dependence upon a first type of user input, a first action may be enabled, and in dependence on detection of a second type of user input, a second type of action may be enabled.

On detection of both a first and second type of user input a third action may be enabled.

The user input may select an object representing a ruler, and the object is adapted to respond to a user input of a first type to move the object, and a user input of the second type when moved along the object draws a line on the display along the edge of the ruler.

The user input may select an object representing a notepad work surface, and the object is adapted to respond to a user input of a first type to move the object, and a user input of the second type when moved on the object draws in the notepad.

The user input may select an object representing a protractor, wherein the protractor can be moved by a user input of the first type at the centre of the object, and the object can be rotated by a user input of the first type at any edge thereof.

An action responsive to detection of a user input may be dependent upon a plurality of user inputs of a different type. Responsive to a user input of a first type an action may be to draw, wherein responsive to a user input of a second type an action may be to move, and responsive to a user input of a first and second type the action may be to slice. For the slice action the first user input may hold the object, and the second user input may slice the object. The action responsive to detection of a user input may be dependent upon a sequence of user inputs of a different type. The action may be further dependent upon at least one property of the selected user interface object. The action responsive to a user input may be further dependent upon a specific area of a user interface object which is selected.

The action may be, in dependence upon an input of a first type, disabling detection of input of a second type in an associated region. The associated region is a physical region defined in dependence upon the location of the input of the first type on the surface. The associated region is a physical region around the point of detection of the input of a first type. The associated region has a predetermined shape and/or predetermined orientation.

The invention provides an interactive display system including an interactive display surface, the interactive display surface being adapted to detect inputs at the surface using a first input detection technology and a second input detection technology, wherein an action responsive to one or more detected inputs is dependent upon the input technology type or types associated with detected input or inputs.

The action may be responsive to two detected inputs of different input technology types. The action may be responsive to said two inputs being detected in a predetermined sequence. The action may be further dependent upon an identifier associated with the one or more inputs. The action may be further dependent upon a control input associated with the one or more inputs. The action may be further dependent upon a control input provided by a further input means.

The first means may be an electromagnetic means. The first type of user input may be provided by an electromagnetic pointer. The second means may be a projected capacitance means. The first type of user input may be provided by a finger.

The invention provides an interactive display system including a display surface, a first means for detecting a first type of user input at the display surface, a second means for detecting a second type of user input at the display surface, and an input device adapted to provide an input of the first type and an input of the second type.

The first type of user input may be an electromagnetic means and the second type of user input is a projected capacitance means for detecting touch inputs, wherein the input device is provided with an electromagnetic means for providing the input of the first type and a conductive area for providing the input of the second type. A frequency of a signal transmitted by the electromagnetic means of the input device may identify the device. A shape of the conductive area of the input device may identify the device. The relative locations of the electromagnetic means and the conductive area may identify the orientation of the device.

The invention provides an input device for an interactive surface including a first input technology type and a second input technology type. The invention provides an interactive display system including an interactive display surface, the interactive display surface being adapted to detect inputs at the surface using a first technology type and a second technology type, wherein the interactive surface is adapted to detect the input device.

In a further aspect the invention provides a method for detecting inputs in an interactive display system including a display surface, the method comprising detecting a first type of user input at the display surface and detecting a second type of user input at the display surface, the method further comprising being selectively responding to an input of a specific type at least one portion of the display surface.

At least one portion of the display surface may be a physical area of the display surface. At least one portion of the display surface may be a plurality of physical areas of the display surface. At least one portion of the display surface may be at least one object displayed on the display surface. At least one portion of the display surface may be a plurality of objects displayed on the display surface. At least one portion may be a part of at least one displayed object. The part of the displayed object may be at least one of a centre of an object, an edge of an object, or all the edges of an object. At least one portion of the display surface may be a window of an application running on the interactive display system. At least one portion of the display surface may be a plurality of windows of a respective plurality of applications running on the interactive display system.

At least one portion may be a part of a displayed window of at least one displayed application.

The at least one portion of the display surface may be selectively responsive to at least one of: i) a first type of user input only; ii) a second type of user input only; iii) a first type of user input or a second type of user input; iv) a first type of user input and a second type of user input; v) a first type of user input then a second type of user input; vi) a second type of user input then a first type of user input; or vii) no type of user input.

At least one portion of the display surface may be responsive to an input of a specific type further in dependence upon identification of a specific user. The user may be identified by the interactive display system in dependence on a user log-in. The at least one portion of the display surface may be dynamically responsive to an input of a specific type. The at least one portion of the display surface may be variably responsive to an input of a specific type over time.

The invention provides a method for detecting inputs in an interactive display system including an interactive display surface, comprising detecting inputs at the interactive display surface using a first input detection technology and a second input detection technology, and defining at least one input property for the interactive display surface which determines whether an input at the interactive surface is detected using one, both or neither of the first and second input detection technologies.

The method may comprise defining a plurality of input properties, each associated with an input condition at the interactive surface. An input condition may be defined by one or more of: a physical location on the interactive surface; an object displayed on the interactive surface; an application displayed on the interactive surface; an identity of a pointing device providing an input; or an identity of a user providing an input. The method may comprise determining an action responsive to a user input in dependence on the type of user input. The method may comprise applying the action to an object at the location of the user input. The method may further comprise determining the action in dependence upon a system input. The system input may be a mouse input, keyboard input, or graphics tablet input.

At least one of the types of user input is an identifiable input device. The method may further comprise determining the action in dependence upon the identity of the identifiable input device providing the user input.

The method may further comprise determining the action in dependence upon the identity of a user associated with an input. The method may further comprise determining the action in response to a user input of a first type and a user input of a second type.

The method may further comprise applying the action to an object, and the action comprising one of the actions: move, rotate, scribble or cut.

The method may further comprise, in dependence upon a first type of user input, enabling a first action, and in dependence on detection of a second type of user input, enabling a second type of action. The method may further comprise, on detection of both a first and second type of user input, enabling a third action.

The method may further comprise selecting an object representing a ruler, and adapting the object to respond to a user input of a first type to move the object, and a user input of the second type when moved along the object to draw a line on the display along the edge of the ruler.

The method may further comprise selecting an object representing a notepad work surface, and adapting the object to respond to a user input of a first type to move the object, and a user input of the second type when moved on the object to draw in the notepad.

The method may comprise selecting an object representing a protractor, wherein the protractor can be moved by a user input of the first type at the centre of the object, and the object can be rotated by a user input of the first type at any edge thereof.

The method may further comprise an action being responsive to detection of a user input in dependence upon a plurality of user inputs of a different type.

The method may further comprise, responsive to a user input of a first type, a drawing action responsive to a user input of a second type a move action, and responsive to a user input of a first and a second type a slice action. For the slice action the first user input may hold the object, and the second user input may slice the object.

The action being responsive to detection of a user input may be dependent upon a sequence of user inputs of a different type.

The action may further be dependent upon at least one property of the selected user interface object.

The action may be responsive to a user input in further dependence upon a specific area of a user interface object which is selected.

The action may be, in dependence upon an input of a first type, disabling detection of input of a second type in an associated region. The associated region may be a physical region defined in dependence upon the location of the input of the first type on the surface. The associated region may be a physical region around the point of detection of the input of a first type. The associated region may have a predetermined shape and/or predetermined orientation.

The invention provides a method for detecting inputs in an interactive display system including an interactive display surface, comprising detecting inputs at the surface using a first input detection technology and a second input detection technology, and enabling an action responsive to one or more detected inputs being dependent upon the input technology type or types associated with detected input or inputs.

The method may comprise enabling the action responsive to two detected inputs of different input technology types. The method may comprise enabling the action responsive to said two inputs being detected in a predetermined sequence. The method may comprise enabling the action further in dependence upon an identifier associated with the one or more inputs. The method may comprise enabling the action further in dependence upon a control input associated with the one or more inputs. The method may comprise enabling the action further in dependence upon a control input provided by a further input means. The first input detection technology may include an electromagnetic means. The first type of user input may be provided by an electromagnetic pointer. The second input detection technology may be a projected capacitance means. The first type of user input is provided by a finger.

The invention provides a method for detecting inputs in an interactive display system including an interactive display surface, comprising detecting a first type of user input at the display surface, detecting a second type of user input at the display surface, and providing an input of the first type and an input of the second type with a single user input device.

The first type of user input may be an electromagnetic means and the second type of user input may be a projected capacitance means for detecting touch inputs, comprising providing the input device with an electromagnetic means for providing the input of the first type and a conductive area for providing the input of the second type.

The method may comprise selecting a frequency of a tuned circuit of the input device to identify the device. The method may comprise shaping the conductive area of the input device to identify the device. The relative locations of the electromagnetic means and the conductive area may identify the orientation of the device.

The invention provides a method for providing an input to an interactive surface comprising providing an input device for the interactive surface including a first input technology type and a second input technology type. The invention provides a method for providing an input to an interactive display system including an interactive display surface, the interactive display surface detecting inputs at the surface using a first technology type and a second technology type, and detecting inputs at the interactive surface from the input device.

### BRIEF DESCRIPTION OF THE FIGURES

The invention will now be described by way of example with reference to the accompanying figures, in which:

FIG. 1 illustrates an exemplary interactive display system;

FIG. 2 illustrates an exemplary interactive display surface incorporating two distinct input technologies;

FIGS. 3a to 3c illustrate three examples in accordance with a first preferred arrangement of the invention;

FIGS. 4a and 4b illustrate exemplary flow processes for processing inputs detected at an interactive surface in accordance with embodiments of the invention;

FIG. 5 illustrates exemplary functional blocks for implementing the process of FIG. 4a;

FIGS. 6a to 6d illustrate four further examples in accordance with the first preferred arrangement of the invention;

FIGS. 7a to 7d illustrate an example in accordance with a second preferred arrangement of the invention;

FIGS. 8a to 8d illustrate a further example in accordance with a second preferred arrangement of the invention;

FIGS. 9a to 9d illustrate a still further example in accordance with a second preferred arrangement of the invention;

FIGS. 10a and 10b illustrate another example in accordance with a second preferred arrangement of the invention;

FIGS. 11a to 11d illustrate a still further example in accordance with a second preferred arrangement of the invention;

FIG. 12 illustrates an exemplary implementation of a process flow in accordance with the second preferred arrangement of the invention;

FIG. 13 illustrates an example in accordance with a further preferred arrangement;

FIG. 14 illustrates an exemplary flow process in accordance with a third preferred arrangement of the invention;

FIG. 15 illustrates an implementation of functional blocks in order to implement the flow process of FIG. 14 in an example;

FIGS. 16a to 16c illustrate an input device adapted in accordance with a fourth arrangement in accordance with embodiments of the invention;

FIGS. 17a to 17c illustrate a further example of an input device in accordance with the fourth arrangement of the invention; and

FIG. 18 illustrates the main exemplary functional elements of a computer system for implementing the invention and its various embodiments.

### DESCRIPTION OF THE PREFERRED EMBODIMENTS

The invention is now described by way of reference to various examples or embodiments, and advantageous applications. One skilled in the art will appreciate that the invention is not limited to the details of any described example or embodiment. In particular the invention is described with reference to an exemplary arrangement of a interactive display system including an interactive surface comprising two specific disparate and independent input technologies. One skilled in the art will appreciate that the principles of the invention are not limited to the two specific technologies described in the exemplary arrangements, and may generally apply to the combination of two or more of any known disparate and independent input technologies suitable for input detection at an interactive surface.

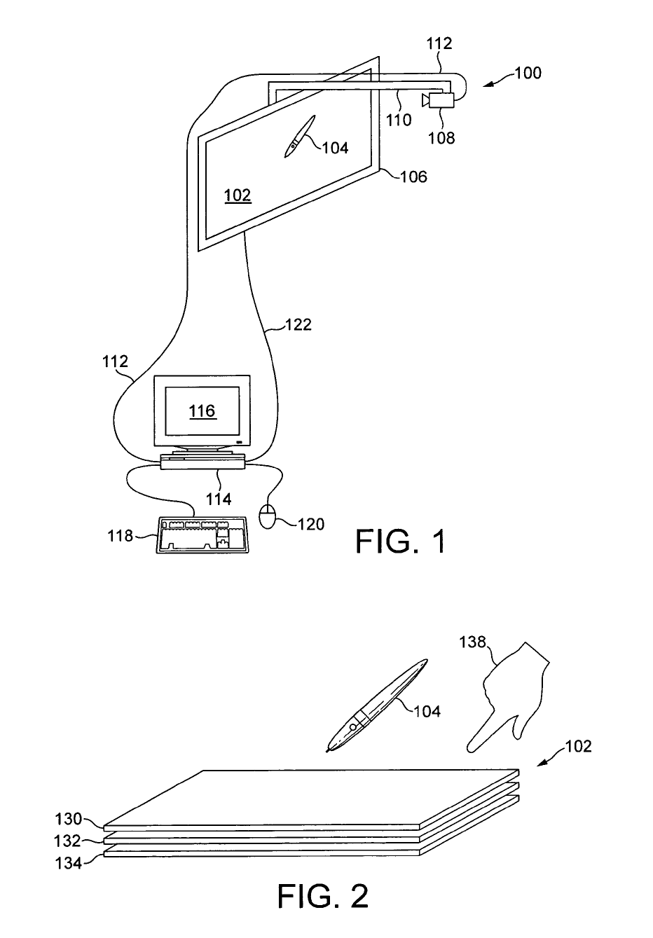

With reference to FIG. 1, an exemplary interactive display system 100 comprises: a whiteboard assembly arrangement generally designated by reference numeral 106, an interactive surface 102; a projector 108; and a computer system 114. The projector 108 is attached to a fixed arm or boom 110, which extends perpendicularly from the surface of the whiteboard 106. One end of the boom 110 supports the projector 108 in a position in front of the interactive surface 102, and the other end of the boom 110 is fixed to the whiteboard 106, a frame associated with the whiteboard 106, or a wall on which the whiteboard 106 is mounted. The computer 114 controls the interactive display system. A computer display 116 is associated with the computer 114. The computer 114 additionally is provided with a keyboard input device 118 and a mouse input device 120. The computer 114 is connected to the whiteboard 106 by a communication line 122 to receive input data from the interactive surface 102, and is connected to the projector 108 by a communication link 112 in order to provide display images to the projector for display on the interactive surface, which may therefore be also referred to as an interactive display surface.

In accordance with the exemplary described arrangements herein the interactive surface 102 is adapted to include a touch-sensitive input means being an example of a first type of input technology, and an electromagnetic input means being an example of a second type of input technology, as described with reference to FIG. 2.

As illustrated in FIG. 2, the interactive surface comprises an electromagnetic interactive layer 134 (sometimes referred to as a digitiser layer) comprising a first type of input means or first type of input technology, and a resistive layer touch-sensitive layer 132 comprising a second type of input means or second type of input technology. A further layer 130 may be provided as a work surface. In the arrangement of FIG. 2 the layer 132 is arranged to overlay the layer 134, and the layer 130 is arranged to overlay the layer 132. In use, the combined layers 130, 132, 134 forming the interactive surface 102 are positioned such that the layer 130 presents a work surface for a user.

The invention is not limited to the arrangement as shown in FIG. 2. Rather than providing the layer 130, the surface of layer 132 may provide the work surface directly. Rather than the layer 132 being formed on the layer 134, the layer 134 may be formed on the layer 132: the layer 130 may then be formed on the layer 134, or the surface layer 134 may provide the work surface directly. In addition to the layers 132 and 134, one or more further layers comprising one or more further types of interactive surface—or more generally input means or input technology—may be provided. Other types of interactive surface include projected capacitance interactive surfaces, and interactive surfaces which utilise camera technology to determine a contact point. It should also be noted that the invention is not limited to the provision of two or more input technologies in two or more distinct layers. The invention encompasses the possibility of two or more input technologies being incorporated in a single layer or single surface, such that the single layer or surface constitutes a plurality of input means.

It should also be noted that the term interactive surface generally refers to a surface which is adapted to include one or more input position detecting technologies for detecting inputs at a work surface or display surface associated therewith. One of the input position detecting technologies may in itself provide the work or display surface, but not all the input detecting technologies provide a surface accessible directly as a work or display surface due to the layered nature of input detection technologies.

In the preferred described arrangement of FIG. 2, the electromagnetic layer 134 detects the pointing device 104 at or near the surface 130. The electromagnetic layer 134 generates an excitation signal, which when reflected by an appropriate tuned or resonant circuit in the pointing device 104, is sensed at the electromagnetic layer to determine the position of the pointing device 104 on the work or display surface layer 130. The touch-sensitive layer 132 detects a finger 138 at the work or display surface 130.

As is known in the art, the computer 114 controls the interactive display system to project images via the projector 108 onto the interactive surface 102, which consequently also forms a display surface. The position of the pointing device 104, or finger 138, is detected by the interactive surface 102 (by the appropriate input technology within the interactive surface: either the electromagnetic input means 134 or the touch sensitive input means 132), and location information returned to the computer 114. The pointing device 104, or finger 138, thus operates in the same way as a mouse to control the displayed images.

The implementation of a display surface including two or more disparate and independent technologies does not form part of the present invention. As mentioned in the background section hereinabove, U.S. Pat. No. 5,402,151 describes one example of an interactive display system including an interactive display surface comprising two disparate and independent technologies. FIG. 2 is representative of an interactive display surface as disclosed in U.S. Pat. No. 5,402,151, the contents of which are herein incorporated by reference. The invention, and embodiments and examples thereof, may be implemented in any interactive display system which incorporates an interactive surface adapted to detect inputs of two or more disparate and independent input types.

In the following discussion of preferred arrangements, reference is made to pen inputs and touch inputs. A pen input refers to an input provided by a pointing device, such as pointing device 104, to an electromagnetic input technology. A touch input refers to an input provided by a finger (or other passive stylus) to a touch sensitive input technology. It is reiterated that these two input technology types are referred to for the purposes of example only, the invention and its embodiments being applicable to any input technology type which may be provided for an interactive surface, as noted above.

In general, in accordance with embodiments of the invention, data from disparate, independent input sources are associated together either permanently or temporarily in specific and/or unique ways, to preferably enhance the user input capabilities for one or more users of an interactive display system incorporating an interactive surface.

In accordance with a first preferred arrangement of the invention, at least one portion of the display surface is adapted to be selectively responsive to an input of a specific type, preferably more than one input of a specific type, preferably at least two inputs each of a different specific type.

In a first example of this first preferred arrangement, the at least one portion of the display surface may be a physical area of the display surface. The at least one portion of the display surface may be a plurality of physical areas of the display surface.

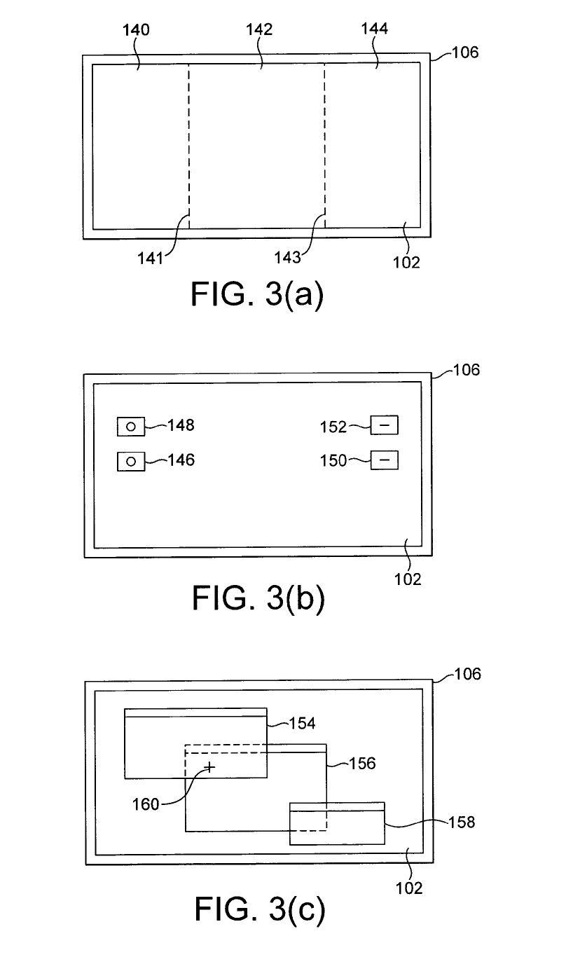

As is illustrated in FIG. 3a, the interactive surface 102 of the whiteboard 106 is shown in an exemplary arrangement where the surface of the interactive surface 102 is split into three distinct physical areas, divided for illustrative purposes by dashed vertical lines 141 and 143. There is thus defined three distinct physical areas denoted by reference numerals 140, 142 and 144. The interactive display system may then be adapted such that in each of the distinct physical areas 140, 142 and 144 there can be defined input properties. The input properties may define, for an area whether no inputs are allowed, only pen inputs are allowed, only touch inputs are allowed, or both pen and touch inputs are allowed.

The arrangement of FIG. 3a is of course illustrative, and the interactive surface 102 may be divided up into distinct physical areas in a variety of possible ways.

In a second example of this first preferred arrangement, the at least one portion of the display surface may be at least one object displayed on the display surface. In an arrangement, the at least one portion of the display surface may be a plurality of objects displayed on the display surface. The at least one portion may be a part of at least one displayed object, or a part or parts of a plurality of displayed objects. The part of the displayed object or objects may be at least one of a centre of an object, an edge of an object, or all of the edges of an object.

With reference to FIG. 3b, there is illustrated the whiteboard 106 with interactive surface 102, on which there is displayed a plurality of objects. In FIG. 3b there is illustrated displayed objects 146, 148, 150 and 152. The objects may be icons associated with a software application, such as an icon providing a “short cut” to “open” a software application. The objects may be displayed objects within an application, such as displayed images or displayed portions of text. The interactive display system may be adapted such that a given displayed object is associated with defined input properties such that it is responsive to a particular type of input, wherever that object is displayed on the interactive surface. Thus if the object 152, for example, is moved to a different location on the interactive surface 102, then the object 152 remains associated with the defined input properties. Thus unlike the example of FIG. 3a, the defined input properties are allocated to a particular object rather than a particular physical area of the interactive surface. The input properties may define, for an object (or object type), whether no inputs are allowed, only pen inputs are allowed, only touch inputs are allowed, or both pen and touch inputs are allowed.

In a third example of this first preferred arrangement, the at least one portion of the display surface may be a window of an application running on the interactive display system. The at least one portion of the display surface may be a plurality of windows of a respective plurality of applications running on the interactive display system. The at least one portion may be a part of a displayed window of at least one displayed application.

With reference to FIG. 3c there is illustrated the whiteboard 106 with the interactive surface 102 having displayed thereon three software applications, denoted by windows 154, 156 and 158. As is known in the art, one of the windows has the input focus of the operating system associated with a computer system controlling the interactive display system. The application associated with such a window is termed to have the input focus of the operating system, and the application is termed to be the foreground application. Other applications not having the input focus are termed to be background applications. In the arrangement of FIG. 3c, the application denoted by reference numeral 154 is the foreground application, and the applications denoted by windows 156 and 158 are background applications. A cross 160 denotes the current position of a cursor associated with the operating system. In this example arrangement, each window 154, 156 and 158 may be associated with particular defined input properties, according to input property definitions associated with their respective applications, such that particular input types may be used to control the applications by inputs being accepted at the windows. It will be seen in FIG. 3c that when the application associated with the window 154 is the foreground application, then any input at the cursor position 160 will be processed in accordance with the defined input properties for the window 154. In the event that the application associated with the window 156 becomes the foreground application, then any input at the cursor position 160 would be processed by the window 156 in accordance with the input properties for that window. Thus, in comparison to the arrangement of FIG. 3a, the input types for the interactive surface are defined in dependence upon the characteristics of a window at which the input is made, rather than the physical location at which the input is made. The input properties may define, for a window (or more generally an application), whether no inputs are allowed, only pen inputs are allowed, only touch inputs are allowed, or both pen and touch inputs are allowed.

One skilled in the art will appreciate that in general input properties may be defined for any displayed item or display area of the interactive surface. The examples given above may also be combined. Where additional or alternative input technologies are associated with an interactive surface, display properties may define whether none, one, some combination, or all of the input technologies are enabled for a portion of the interactive surface, whether a physical portion or portion associated with a currently displayed image (such as an object or application window).

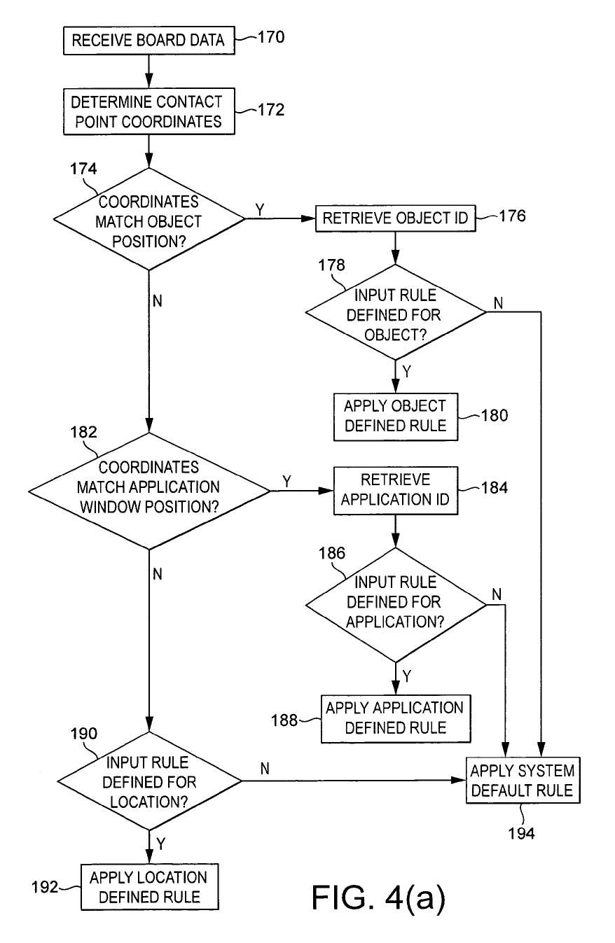

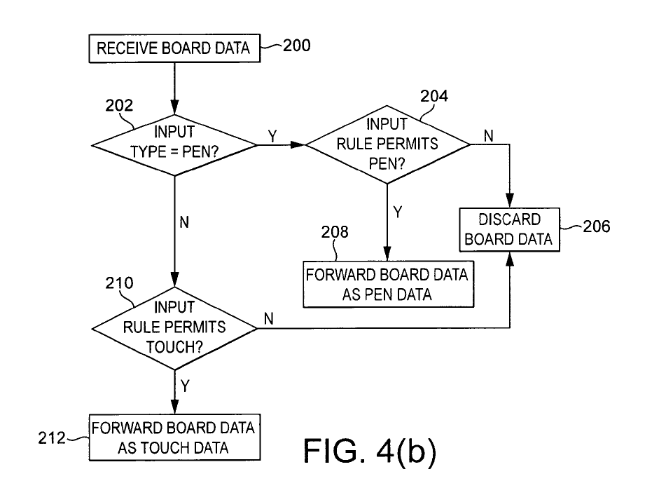

With reference to FIG. 4a, there is illustrated an exemplary flow process for processing inputs detected at the interactive surface 102 in accordance with the first preferred arrangement of the invention and more particularly the first, second and third examples of the first preferred arrangement described hereinabove.

In a step 170 board data from the interactive whiteboard 106 is received by the computer associated with the interactive display system. The term board data refers generally to all input data detected at the interactive surface—by any input technology—and delivered by the interactive surface to the computer.

In a step 172 the coordinates of the contact point(s) associated with the board data is/are then calculated by the computer in accordance with known techniques.

In step 174 it is determined whether the calculated coordinates match the current position of an object. In the event that the coordinates do match the current position of an object, then the process proceeds to step 176 and an identifier (ID) associated with the object is retrieved. In a step 178 it is then determined whether an input rule (or input property) is defined for the object, based on the object identity. If no such input rule is defined, then the process moves on to step 194, and a default rule (or default property) is applied. If in step 178 it is determined that there is an input rule defined for the object, then the process moves on to step 180 and the object defined rule is applied.

If in step 174 it is determined that the calculated coordinates do not match a current object position, then in step 182 it is determined whether the calculated coordinates match the current position of an application window. If it is determined in step 182 that the coordinates do match the position of an application window, then in a step 184 an identity (ID) for the application is retrieved. In a step 186 it is then determined whether there is an input rule (or input property) defined for the application. If no such input rule is defined, then the method proceeds to step 194 and the default rule is applied. If there is an input rule defined for the application, then in a step 188 the application defined rule is applied.

If in step 182 it is determined that the calculated coordinates do not match a current position of the application window, then in a step 190 a determination is made as to whether an input rule (or input property) is defined for the physical area on the interactive surface. If no such input rule is defined, then in a step 194 the default rule for the system is applied. If in step 190 it is determined that there is an input rule defined for the location, then in step 192 the defined rule for the physical area is applied.

It should be noted that FIG. 4a represents only an illustrative example implementation. The described example effectively requires that an object takes priority over an application window, and an application window take priority over a physical area. In other examples alternative implementations may be provided to have a different priority. In addition, only one or more of the decisions 174, 182 and 190 may be implemented, in the event that, for example, input type can only be defined by way of physical area, or only by the presence of an application window.

One skilled in the art will recognise that various modifications may be made to the process of FIG. 4a. For example, following a negative determination in step 178, the method may proceed to step 182; following a negative determination in step 186 the method may proceed to step 190. One skilled in the art will also recognise that alternative processes other than that illustrated in FIG. 4a may be implemented to determine the processing of board data in accordance with one or more defined input property or rule.

With regard to FIG. 4b, there is illustrated an exemplary process flow for the further processing of board data once a defined input rule or input property has been determined using, for example, the exemplary flow of FIG. 4a.

In a step 200 the board data is received. In a step 202 a determination is then made as to whether the input type is a pen-type, i.e. a non-touch input. In the event that the input type is a pen-type, then in a step 204 it is determined whether the determined input rule(s) (defined following the implementation of the process of FIG. 4a) permit pen inputs. If pen inputs are permitted, then in a step 208 the board data is forwarded as pen data (or simply as general input data) for further processing. If pen inputs are not permitted, then in a step 206 the board data is discarded.

If following step 202 it is determined that the input type is not a pen-type, then it is assumed to be touch type and in step 210 a determination is made as to whether the determined input rule(s) permit touch inputs. If the input rule does permit touch, then in a step 212 the board data is forwarded as touch data (or simply as general input data). If the input rule in step 210 dictates that touch inputs are not permitted, then in step 206 the board data is discarded.

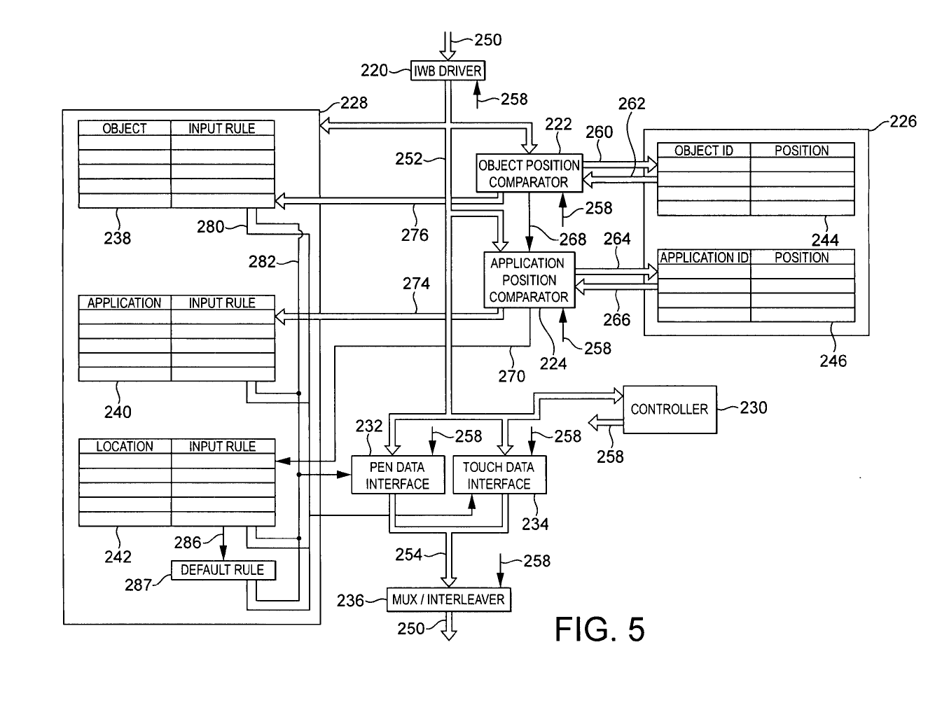

Turning now to FIG. 5, there is illustrated an exemplary implementation of functional blocks in the computer system associated with the interactive display system in order to implement the process flows of FIGS. 4a and 4b. The functional blocks of FIG. 5 represent functional blocks of the computer system associated with the interactive display system. One skilled in the art will appreciate that additional functionality is required to fully implement the computer system, and only those exemplary elements necessary to understand the implementation of the techniques of this exemplary arrangement of the invention are illustrated.

With reference to FIG. 5, there is illustrated an interactive whiteboard driver 220, an object position comparator 222, an application position comparator 224, a pen data interface 232, a touch data interface 234, a multiplexer/interleaver 236, a controller 230, an object and application position location block 226, and an input rules block 228.

A controller 230 generates control signals on a control bus 258, one or more of which control signals are received by the interactive whiteboard driver 220, the object position comparator 222, the application position comparator 224, the pen data interface 232, the touch data interface 234, or the multiplexer/interleaver 236.

The interactive whiteboard driver 220 receives the board data on a board data bus 250, and delivers it in an appropriate format on an input data bus 252. The input data bus 252 is connected to deliver the input data received by the interactive whiteboard driver 220 to the object position comparator 222, the application position comparator 224, the pen data interface 232, the touch data interface 234, the input rules store 228, and the controller.

The controller 230 is adapted to calculate coordinate information for any board data received, in dependence on the board data received on the input bus 252. Techniques for calculating coordinate information are well-known in the art. For the purposes of this example, the coordinate data is provided on the input data bus 252 for use by the functional blocks as necessary.

The object position comparator 222 is adapted to receive the board data on the input data bus 252, and the location (coordinate) data associated with such data, and deliver the location data to an object position store 244 within the position location block 226 on a bus 260. The coordinate data is delivered to the object position store 244, to determine whether any object positions in the object position store 244 match the coordinates of the received board data. In the event that a match is found, then the identity of the object associated with the location is delivered on identity data bus 262 to the object position comparator 222. The retrieved identity is then applied to an object rule store 238 within the rules store 228 using communication line 276, to retrieve any stored input rules for the object identity. In the event that a match is found for the object identity, then the input rules associated with that object identity are provided on the output lines 280 and 282 of the rules store 228, and delivered to the pen data interface 232 and the touch data interface 234. Preferably the output lines 280 and 282 are respective flags corresponding to pen data input and touch data input, indicating with either a high or a low state as to whether pen data or touch data may be input. Thus the output lines 280 and 282 preferably enable or disable the pen data interface 232 and the touch data interface 234 in accordance with whether the respective flags are set or not set.

In the event that the object position comparator 222 determines that there is no object at the current position, then a signal is set on line 268 to activate the application position comparator.

The application position comparator operates in a similar way to the object position comparator to deliver the coordinates of the current board data on a position data bus 264 to the application position store 246 within the position store 226. In the event that a position match is found, then an application identity associated with that position is delivered on an application data bus 266 to the application position comparator 224. The application position comparator 224 then accesses an application input rule store 240 within the rules store 228 by providing the application identity on bus 274, to determine whether there is any input rule associated with the identified application. As with the object rule store 238, in the event that there is an associated input rule, then the outputs on lines 280 and 282 of the rule store 228 are appropriately set.

In the event that the application position comparator 224 determines that there is no application at the current position, then a signal is set on line 270 to enable a location input rule store 242 to utilise the coordinates of the detected contact point to determine whether an input rule is associated with the physical location matching the coordinates. Thus the coordinates of the contact point are applied to the location input rule store 242 of the rules store 228, and in the event that a match is found the appropriate input rules output on signal lines 280 and 282. In the event that no match is found, then a signal on line 286 is set by the location input rule, to enable a default rule store 287. The default rule store 287 then outputs the default rules on the output lines 280 and 282 of the rules store 228.

The pen data interface 232 and touch data interface 234 are thus either enabled or disabled in accordance with any input rule or default rule applied. The board data on the input data bus 252 is delivered to the pen data interface and touch data interface 232 and 234 respectively, in accordance with whether the input data is associated with either a pen input or a touch input. The input data on the input data bus 252 is then delivered to an output data bus 254 by the respective interfaces 232 and 234, in accordance with whether those interfaces are enabled or disabled. Thus pen data and touch data is only delivered on the output interface 254 in the event that the pen data or touch data interfaces 232 and 234 are respectively enabled, otherwise the data is discarded.

The multiplexer/interleaver 236 then receives the data on the output data bus 254, and delivers it on a bus 256 for further processing within the computer system as known in the art.

The arrangement of FIG. 5 is purely an illustrative example of an implementation. The arrangement of FIG. 5 assumes that it is determined whether board data is associated with an object or an application in dependence on location information. In alternatives other techniques may be used to determine whether input data is associated with an object or application. For example, all board data may be routed through the multiplexer/interleaver 236 to an operating system, where a decision is made by the application itself as to which data to process in dependence on the input properties or rules for an application.

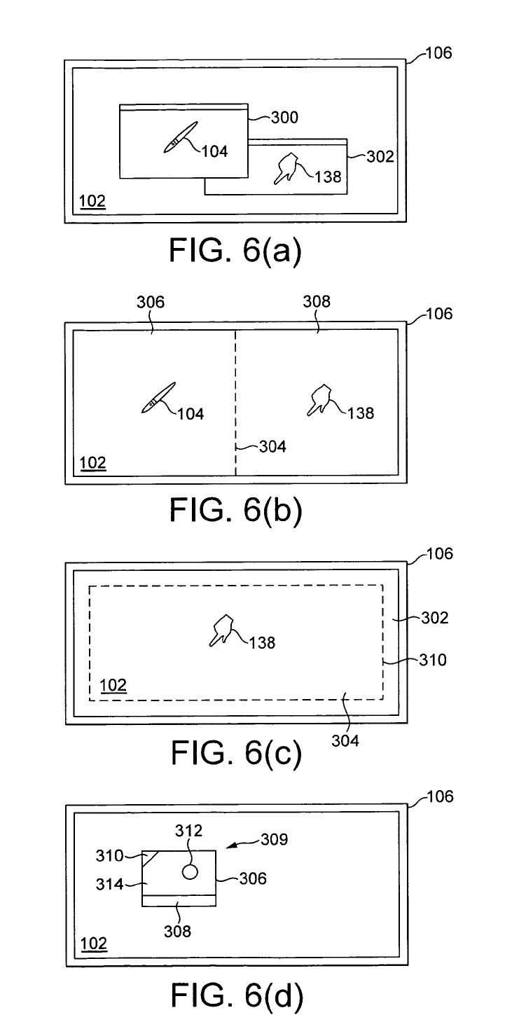

Thus in accordance with an example of the first preferred arrangement there may be provided an implementation where one type of user input is a touch input, and the other type of user input is a pen input, the interactive display system may be adapted generally for one or more specific user sessions, or for one or more activities, to allow specific control of one or more applications, one or more objects or parts of objects, or one or more areas of the general input surface, such that the system allows for: no interaction; interaction via touch only; interaction via pen only; interaction via touch or pen; interaction via touch and pen; interaction via touch then pen; or interaction via pen then touch. Further examples in accordance with the first preferred arrangement are now described with reference to FIGS. 6a to 6d.

In an exemplary implementation in accordance with the third example of the first preferred arrangement, a software developer may write an application with the intention for it to be used in association with touch inputs. In writing the application, the characteristic or property of touch inputs may be stored with the application as an associated input property or rule. This characteristic or property then dictates the operation of the interactive surface when the application runs. As such, during the running of the application the interactive display system only allows actions responsive to touch inputs.

With reference to FIG. 6a, there is illustrated the interactive whiteboard 106 on which there is displayed on the interactive surface 102 a first window 302 associated with a first application and a second window 300 associated with a second application. In an exemplary arrangement, each application associated with the respective windows is adapted to have input properties which define a specific type or types of input for that application. As illustrated in the example of FIG. 6a, the window 302 is adapted to receive only touch inputs from a finger of a hand 138, and the window 300 is adapted to receive only pen inputs from a pointing device 104.

As an extension to this example, a developer may write an application with associated input properties or rules which allow for the switching of the input-type during the running of the application, for example to suit certain sub-activities within it. Again, the appropriate characteristic or property of the input-type may be stored with the application, in association with the sub-activities. When an appropriate sub-activity is enabled within the running of the application, the input properties can be appropriately adapted, so as to allow or enable the appropriate type of input which the developer has permitted.

With further reference to FIG. 6a, the window 300 may be a sub-window opened through activating a function within the window 302. Thus both windows may be associated with the same application, one window being a sub-window of the other. In such an arrangement the window 300 being a sub window may still be adapted to have a defined set of input characteristics, which are defined independently of the input characteristics of the main window 302. Thus in such an arrangement the main window 302 may be responsive only to touch, whereas the sub-window 300 may be responsive only to pen inputs.

In these examples, the application, or a sub-activity of the application, is associated with a particular type of input. Thus the interactive display system is adapted such that a window associated with that application, or the sub-activity of the application, is adapted to be responsive to the appropriate inputs. In the event that that window is not a full-screen window, and occupies only a part of the display screen, then the restrictions to the type of input apply only to the area in which the window is displayed.

In general, the selective control of the type of input enabled can apply to specific applications or to the operating system in general.

In an exemplary implementation in accordance with the first example of the first preferred arrangement, the display surface may be split into two physical areas. A vertical separation may generally run midway through the board, in one example, such that the left-hand side of the interactive surface is touch only, and the right-hand side of the interactive surface is pen only. In this way the physical areas of the board are split to allow only inputs of a certain type, such that any input in those parts of the board, regardless of the application running there, are only accepted from a certain type of input. Each physical area has a defined input property or properties.

With reference to FIG. 6b, there is illustrated an arrangement in which the interactive surface 102 is divided in two halves, by generally a left-hand part 306 and a right-hand part 308. A dash vertical line 304 denotes the nominal separation between the two halves. The two distinct physical areas of the interactive surface may then be associated with defined user input conditions, such that only a pen 104 may be detected in the area 306, and only a touch input 138 may be detected in the area 308.

In an alternative exemplary implementation of the first example of the first preferred arrangement, physical portions of the interactive surface may be adapted such that the perimeter of the interactive surface ignores touch inputs. This allows hands, arms and elbows—for example—to be ignored when users are sat around an interactive surface which is oriented horizontally in a table arrangement. Thus inputs associated with a user leaning on the table surface are ignored.

FIG. 6c illustrates an arrangement in which the interactive surface 102 is adapted such that a border thereof is adapted not to be responsive to touch, whereas a central portion thereof is responsive to touch. Thus a dash line 310 denotes the region of a border along all four sides of the interactive surface. An area 304 within the dash line is a work area for a user (or users), which is adapted to be sensitive to touch inputs. The border area 302 outside the dash line 310 is adapted such that it is disabled for touch inputs. In such an arrangement the area 302 may be disabled for any inputs, or only for touch inputs. It may alternatively be possible for a pen input to be detected across the entire interactive surface 102 including region 302.

In a further example in accordance with the second example of the first preferred arrangement, an object may be adapted such that different parts of the object are responsive to different user inputs. This example is an extension to the example of FIG. 3b described above. With reference to FIG. 6d an object generally denoted by reference numeral 309 is displayed on the interactive surface 102. The object 309 has a portion running along a bottom area thereof, forming a lower part of the object, and denoted by reference numeral 308. A main body of the object is referred to by reference numeral 314. A corner region of the object is denoted by reference numeral 310, a displayed portion of the object within the main body 314 of the object is denoted by reference numeral 312. In accordance with this arrangement, each part of the object may be associated with specific defined input properties. Thus the corner 310 may be responsive to a particular defined set of user inputs, and the other parts of the object 312 and 308 may be associated with their own defined user input types. The main body of the object 314 may also be associated with its own user input type. Thus the corner 310 may only be responsive to a pen input, whereas the body 314 may be responsive to a touch input. As will be described further hereinbelow with reference to a second preferred arrangement, this may allow an object to be manipulated in a particular way in dependence not only on the type of user input used to select the object, but the position on the object where such user input is detected.

In accordance with examples of the first preferred arrangement as described above, at least one portion of the display surface may be adapted to be selectively responsive such that it is not responsive to any user input type, or that it is responsive to at least one of: i) a first type of user input only; ii) a second type of user input only; or iii) a first type of user input or a second type of user input.

In accordance with a second preferred arrangement, an action responsive to a user input may be dependent upon the type of user input or a combination of user inputs.

Thus a different action may be implemented in dependence on whether a user input or user input sequence is: i) of a first type only; ii) of a second type only; iii) of a first type or a second type; iv) of a first type and of a second type; v) of a first type followed by a second type; or vi) of a second type followed by a first type.

Such an action may be applied to an object at the location of the user input.

The action may be still further dependent upon a system input. The system input may be a mouse input, a keyboard input, or a graphics tablet input.

The action may be further dependent upon an identity of an input device providing the user input.

If the action is applied to an object, the action may for example comprise one of the actions: move; rotate; scribble; or cut.

Thus, for each input property or input rule defined, there may be defined an additional property which defines a type of action that should occur when an input or sequence of inputs is detected of one or more input types at the interactive surface, preferably when such input or sequence of inputs is associated with a displayed object.

Thus, as discussed above, in an example one or more objects may be given one or more of the following properties: interact via touch; interact via pen; interact via touch or pen; interact via touch and pen; interact via touch then pen; or interact via pen then touch. Responsive to the particular input type detected when an object is selected, a particular action may take place. Thus whilst a particular object may be adapted so that it is only responsive to one of the various types of inputs described above, in an alternative the object may be responsive to a plurality of types of inputs, and further be responsive to a particular combination of multiple inputs, such that a different action results from a particular input sequence.

Thus, for example, selecting an object via touch then pen may result in a move action being enabled for the object, whereas selecting an object via touch and pen simultaneously may result in a rotate action being enabled for the object.

In a general example, in dependence upon a first combination of user inputs, a first action may be enabled, whereas in dependence of a second combination of user inputs, a second type of action may be enabled. An action may be also referred to as a mode of operation.

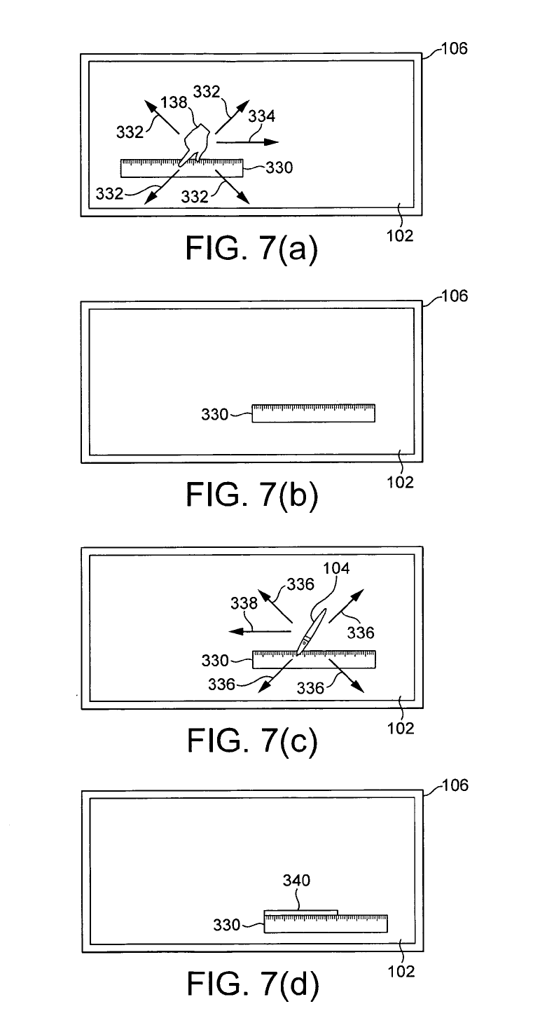

In an example, a user input may select an object displayed on the display surface which object is a graphical representation of a ruler. The properties of the object may be adapted such that it is enabled to respond to a user input of a first type to enable movement of the object, and a user input of a second type, when moved along the object, enable drawing of a line on the display along the edge of the ruler. Thus, for example, responsive to a touch input on the ruler object the ruler object may be moved around the surface by movement of the touch input. Responsive to a pen input on the ruler object, and generally moving along the ruler object, the ruler object cannot be moved, but a line is drawn in a straight fashion along the displayed edge of the ruler object. This can be further understood with reference to the example illustrated in FIGS. 7a to 7d.

With reference to FIG. 7a there is illustrated a ruler object 330 displayed on the interactive surface 102 of the electronic whiteboard 106. As can be seen in FIG. 7a, a user's finger is brought into contact with the interactive surface at a point at which the ruler object 330 is displayed, by bringing a hand 138 to the surface. The hand 138 may be moved anywhere about the interactive surface, as denoted by various arrows 332, whilst in contact with the ruler object 330. In accordance with the input properties or rules associated with the ruler object 330, the ruler object 330 will be moved about the interactive surface 102 in correspondence with the movement of the touch contact provided by the hand 138. In a preferred arrangement, it is assumed that the hand 138 is moved in a generally horizontal direction as denoted by arrow 334, to move the ruler from a left-hand area of the interactive surface 102 to a right-hand area of the interactive surface 102. The new position of the ruler object 330 in the right-hand section of the interactive surface 102 is illustrated in FIG. 7b.

With reference to FIG. 7c, a pointing device 104 is brought into contact with the interactive surface 102, the contact point of the pointing device 104 being coincident with the displayed ruler object 330. As illustrated by arrows 336 in FIG. 7c, the pointing device 104 may of course be moved in any direction around the interactive surface 102 from the initial contact point at the ruler object 336. In one arrangement, any movement of the pointing device 104 following initial contact at the ruler object 336 is translated into a horizontal movement, and a line drawn along the “edge” of the displayed ruler object corresponding to that translated horizontal movement. Thus if the pointing device 104 moves in a generally diagonal and upwards direction away from the ruler object 330, the horizontal portion of such movement may be translated into a straight line drawn along the top edge of the ruler object 330. Preferably, however, it may well be that such movement of the pointing device is only translated into a drawn straight line in the event that the movement stays within a certain distance of the displayed object, and is clearly associated with an intention of the user of the pointing device 104 to draw a straight line associated with the ruler edge. In the described example it is assumed that the pointing device 104 is moved in a generally horizontal direction as denoted by arrow 338, towards the left-hand side of the interactive surface 102. As can be seen in FIG. 7d, a straight line 340 is then drawn along the edge of the displayed ruler object from a point adjacent to the initial contact point with the object, through to the left-hand edge of the ruler which corresponds to the movement of the pointing device 104.

Thus it can be seen with reference to FIGS. 7a to 7d, a touch contact point allows for the ruler object to be moved, whereas a pointing device contact allows for a line to be drawn. There is no requirement for a mode of operation having to be selected using menu selections in order to determine what action will happen responsive to a user input, the availability of multiple user input detection technology types being used to determine a specific action that will occur for a specific input type. Such an arrangement is much more efficient than the need for a user to select functionality from a menu option, to switch between, for example, moving of the object and drawing with the object.

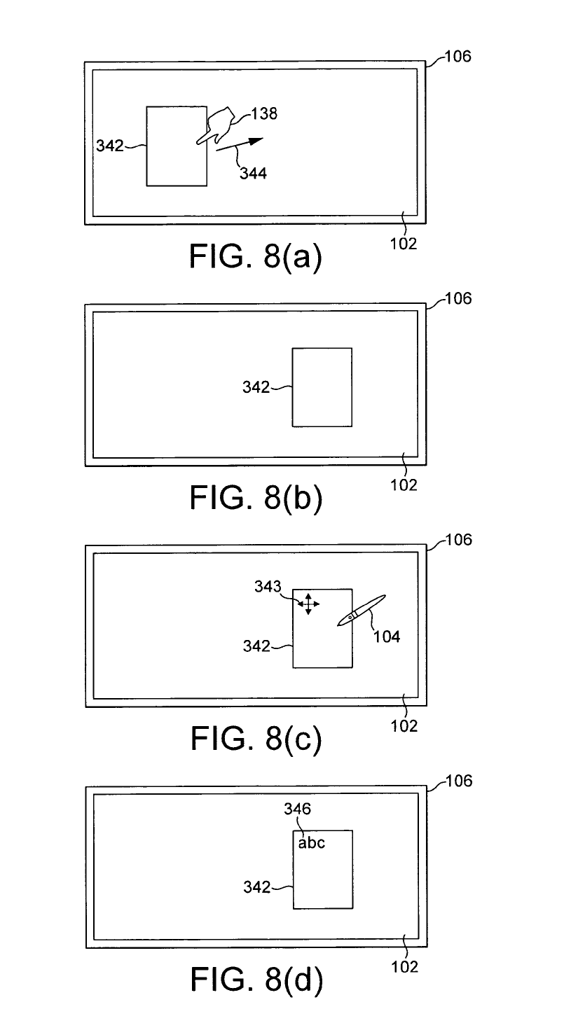

In another example, the user input may select an object representing a notepad work surface. Such an object may be adapted to respond to a user input of a first type to move the object, and a user input of a second type when moved on the object draws in the notepad. Thus a touch input can be used to move the notepad, and a pen input can be used to draw in the notepad. This can be further understood with reference to the example illustrated in FIGS. 8a to 8d.

With reference to FIG. 8a, there is illustrated a displayed notepad object 342 on the interactive surface 102 of the electronic whiteboard 106. A touch contact denoted by a hand 138 is made at the interactive surface 102, at a location coincident with the displayed notepad object 342. The hand 138 may then be moved around the interactive surface 102 in any direction. As denoted by arrow 344, the hand 138 is generally moved in a direction to the right and upwards on the interactive surface 102. As shown in FIG. 8b, the displayed notepad object 342 is then moved to a new location to the right and upwards of the original location. Thus the movement of the contact point provided by a touch input across the interactive surface results in a movement of the displayed notepad object.

As illustrated in FIG. 8c, a pointing device 104 is brought into contact with the interactive surface 102, at a location which is coincident with the displayed notepad object 342. As denoted by the arrows 343, the pointing device 104 may be moved in any direction over the interactive surface 102 following the initial contact. This may be the result of, for example, an intention of the user of the pointing device 104 to write or draw in the notepad associated with the displayed notepad object 342. As illustrated in FIG. 8d, as a result of the movement of the pointing device 104 text “abc” is written into the notepad as denoted by reference numeral 346. Thus the movement of the pointing device 104 results in input annotations being made into the displayed notepad object, and the displayed notepad object is not moved.

Thus it can be understood with reference to FIGS. 8a to 8d that an arrangement is provided in which responsive to a touch input a displayed notepad object can only be moved, whereas responsive to a pointing device input a displayed notepad object can be only edited.

The examples in accordance with this second preferred arrangement can be further extended (as noted above) such that any action is additionally dependent on other input information, such as mouse inputs, keyboard inputs, and/or inputs from graphic tablets. Input information may also be provided by the state of a switch of a pointing device. This allows still further functional options to be associated with an object in dependence on a detected input.

An action is not limited to being defined to control manipulation of an object or input at the interactive surface. An action may control an application running on the computer, or the operating system, for example.

In an extension of the second preferred arrangement, and as envisaged above, an action responsive to detection of a user input may be dependent upon a plurality of user inputs of a different type rather than—or in addition to—a single input of a specific type.

In an example in accordance with this extension of the second preferred arrangement, responsive to a user input of a first type an action may be to draw, wherein responsive to a user input of a second type an action may be to move, and responsive to a user input of a first and second type together an action may be to slice.

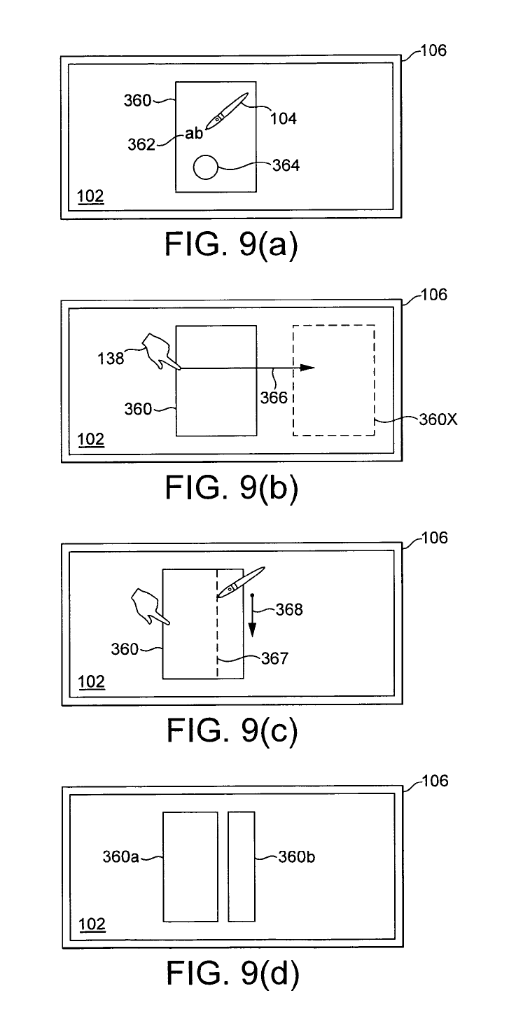

This can be further understood with reference to an example, illustrated in FIGS. 9a to 9d, where a displayed object represents a graphical representation of a sheet of paper. Responsive to a pen input only, a resulting action is to allow a “draw” operation to take place. Responsive to a touch input only, a resulting action is to allow a “move” operation to take place. Responsive to a pen and touch input combined, a resulting action is a “slice” operation, allowing the user to pin the paper in place with a finger, while splitting or tearing the surface into smaller sections using the pen. In this example, the pen intuitively starts to behave like a knife cutting the paper.

With reference to FIG. 9a there is illustrated a displayed object 360 representing a sheet of paper, which is displayed on the interactive surface 102 of the electronic whiteboard 106. In FIG. 9a there is illustrated a pointing device 104 which is brought to the interactive surface and having a contact point coincident with the paper object 360. As the pointing device 104 is moved around the paper object 360, a draw or write operation may take place, such that text “ab” as denoted by reference numeral 362 is entered, or a drawing object such as a circle 364 is drawn.

As illustrated in FIG. 9b, the same paper object 360 is displayed on the interactive surface 102 of the electronic whiteboard 106, and a touch contact denoted by hand 138 is brought to the interactive surface at a location coincident with the paper object 360. Responsive to movement of the touch contact, as denoted by arrow 366, the paper object 360 is moved to a new location, as indicated by the dashed outline of the object 360 at a new location.

As illustrated by FIG. 9c, in a third arrangement a touch contact 138 is made at the interactive surface 102 at a location coincident with the displayed paper object 360. Further a pen contact is made at the interactive surface 102 at a location coincident with the paper object 360. The touch contact provided by the hand 138 is not moved, whilst the pen 104 is moved across the surface of the object as denoted by the arrow 368, in a direction denoted by the dash line 367. As a result, and as illustrated in FIG. 9d, the movement of the pointing device in a direction 368 along a portion of the paper object denoted by dash line 367 results in the paper object being cut along the dash line 367, to form a first part of the object 360a and a second separate part of the object 360b.

Thus, for the slice action the first user input type holds the object, and the second user input type slices the object. The action responsive to detection of a user input may thus be dependent upon a sequence of user inputs of a different type.

An action may further be dependent upon at least one property of a selected user interface object. Thus, for example, in the above-described example the action to slice the object may be dependent upon the object having a property which indicates that it may be sliced.

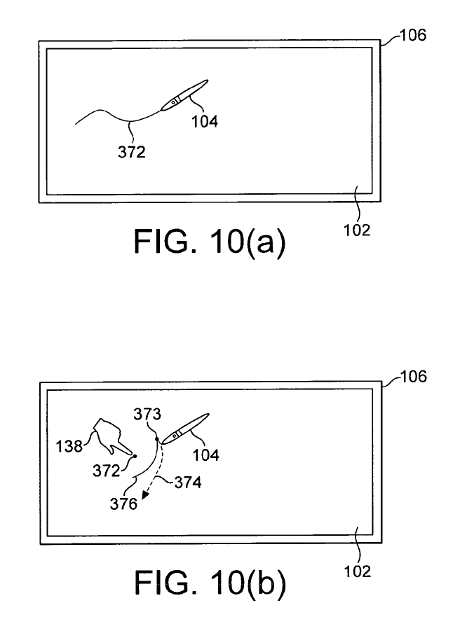

In a further example in accordance with the extension of the second preferred arrangement, using a pen input only allows for freehand drawing on the interactive surface. However a touch input followed by a pen drawing action, may cause an arc to be drawn around the initial touch point, the radius of the arc being defined by the distance between the touch point and the initial pen contact. This is further explained with reference to FIGS. 10a and 10b.

With reference to FIG. 10a, there is shown a pointing device 104 at the interactive surface 102 of the interactive whiteboard 106. As illustrated in FIG. 10a, following a free hand movement of the pointing device 104 over the interactive surface 102 a line 372 is drawn on the displayed image on the interactive surface.

With reference to FIG. 10b, a touch contact point is made at a point 372 on the interactive surface 102, as a result of a hand 138 being brought into contact with the interactive surface. Thereafter the pointing device 104 is brought into contact with the interactive surface at the point 373, and is generally moved around the contact point 372 as indicated by the dashed arrow 374. In accordance with this preferred arrangement, the movement of the pointing device 104 is translated into an accurate arc 376 drawn around the contact point 372, having a fixed radius which is determined by the distance between the contact points 372 and 373.

As discussed above, any action responsive to any user input or sequence of inputs may be dependent upon a specific area of a user interface object which is selected, rather than just the object itself. Thus specific areas of an object may be defined to be responsive to specific types of input or combinations of input. Thus a part of an object may be associated with a property type. Typical areas of an object which may have specific properties associated therewith include: an object centre; all edges of an object; specific edges of an object; and combinations of edges of an object.

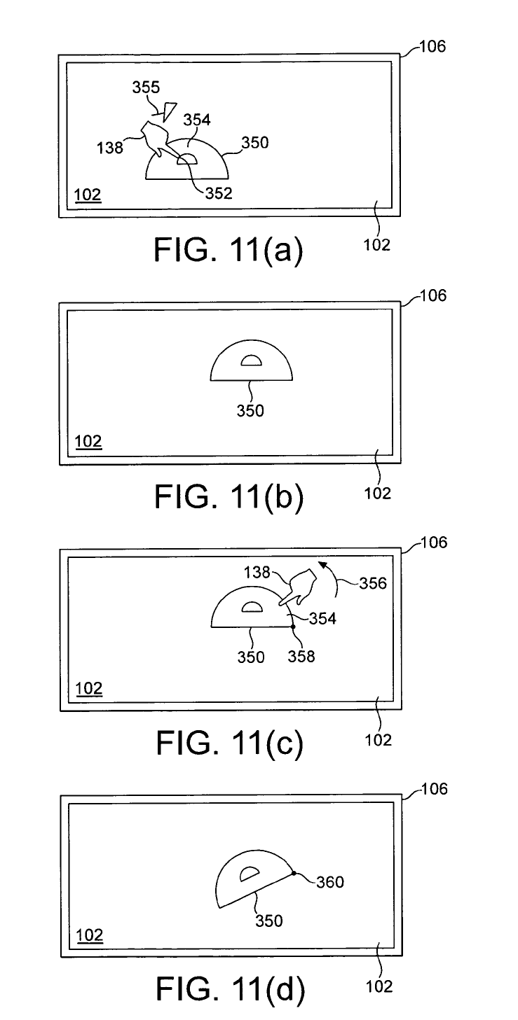

In a particular example, described with reference to FIGS. 11a to 11d, a displayed object may be a graphical representation of a protractor. A user input may select such a protractor object. The protractor can be moved by a user input of the first type (such as a touch input) when the user input of the first type is detected at the centre of the object, and the object can be rotated by a user input of the first type (such as a touch input) when the user input is detected at any edge of the object.

With reference to FIG. 11a, there is illustrated an interactive surface 102 of the interactive whiteboard 106 on which there is displayed a protractor object 350. The protractor object has a central region generally designated by reference numeral 352, and the remainder of the protractor can be generally considered to have an outer region denoted by reference numeral 354. As illustrated in FIG. 11a a hand 138 is brought to the interactive surface 102 to make a touch contact with the protractor object 350 at the central region 352 thereof. As denoted by arrow 355, the hand 138 then moves in a direction towards the right of the interactive surface 102 and generally upwards. As illustrated in FIG. 11b, the protractor object 350 is then moved in a corresponding manner associated with the movement of the hand, and is displayed in a new location.

As illustrated in FIG. 11c, the hand 138 is brought into contact with the interactive surface 102, at the outer region 354 of the protractor object 350. The hand 138 is then moved generally in a direction 356 to indicate rotation of the protractor object 354. As a result of such movement, and as indicated in FIG. 11d, the protractor object 350 is rotated about a rotation point 358. In the described example the rotation point 358 is a corner of the protractor object. In alternative arrangements the rotation points may be different.

Thus there can be seen with reference to FIGS. 11a to 11d that the action responsive to a particular type of input may differ according to the location on the object where the contact point is made, as well as being dependent upon the type of input associated with the contact point. The protractor object of FIGS. 11a to 11d may be further adapted such that responsive to a pen input at the edge thereof, an arc is drawn around the edge following the shape of the protractor, similar to the ruler object example for drawing a straight line give above.

Thus an object can be manipulated in a number of different ways in dependence upon properties defined for the object, without having to resort to selecting functional options from a list of menu options, in order to achieve the different manipulations.

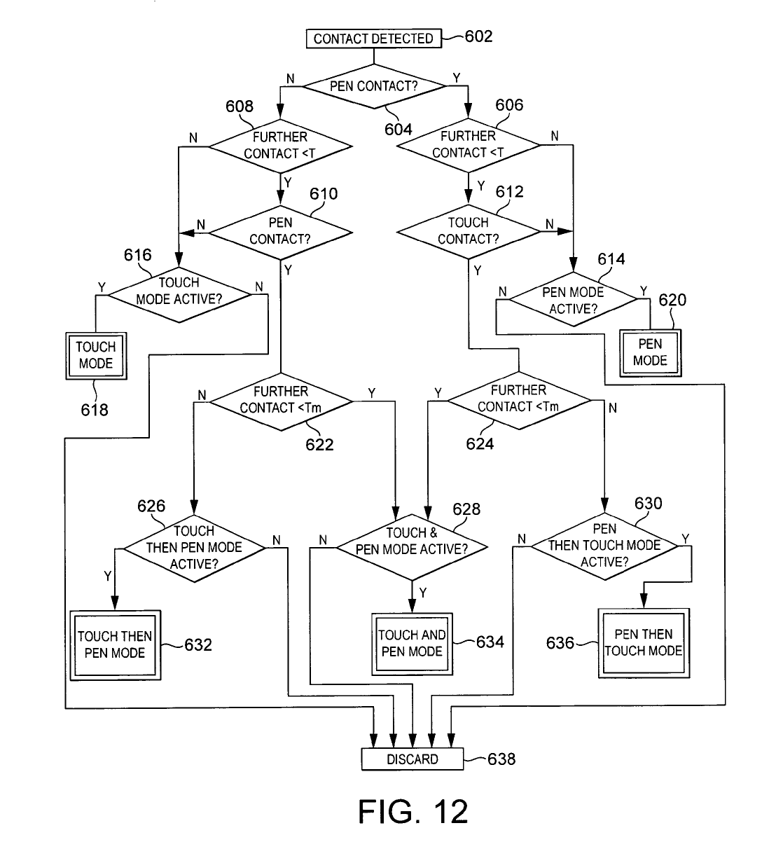

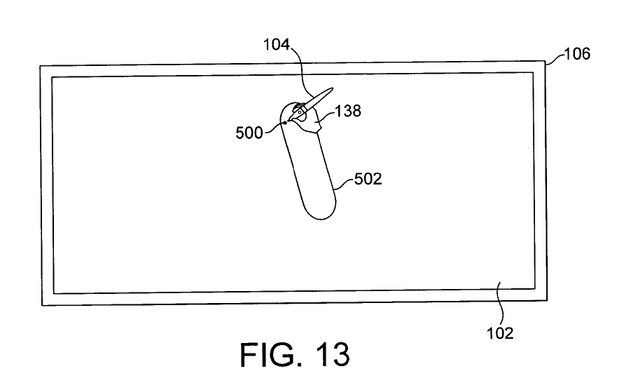

With reference to FIG. 12, there is illustrated an exemplary implementation of a flow process in accordance with the second preferred arrangement, for determining a mode of input at the interactive surface, which mode may then determine an action to be implemented. The mode may be determined in dependence on a particular location at the interactive surface at which one or more contact points are detected, such as a location defined by an object, an application window, or a physical area.

Turning to FIG. 12, in a step 602 a contact point is detected at the interactive surface. In a step 604 it is then determined whether the contact point is associated with a pen contact. In the example it is assumed that only a pen contact or a touch contact is permitted at the surface, and therefore in the event that a contact is not a pen contact it is a touch contact.

If in step 604 it is determined that the contact detected is a pen contact, then in a step 606 it is determined whether a further contact is received within a time period T of the first contact. In step 606 if no such contact is detected, then in a step 614 it is determined whether pen mode is active or enabled. If pen mode is active or enabled, then in step 620 pen mode is entered or maintained.

A particular mode of operation is enabled if the input properties for the physical area, object or application are defined to allow that mode of operation. The action responsive to a particular mode being entered is determined by the properties for that mode allocated to the physical area, object or location.

If in step 614 it is determined that pen mode is not active or enabled, then the process moves to step 638 and the input data associated with the contact point is discarded.

If in step 606 it is determined that a further contact is detected within a time period T, then the process moves on to step 612. In step 612 it is determined whether the second contact following the first contact (which is a pen contact) is a touch contact. If the second contact is not a touch contact, i.e. it is a second pen contact, then the process continues to step 614 as discussed above.

If in step 612 it is determined that the second contact is a touch contact, then it is determined whether the second contact was received within a time period T_{M} in a step 624. If the time condition of step 624 is met, then in step 628 it is determined whether a touch and pen mode is active or enabled. If in step 628 it is determined that the touch and pen mode is active or enabled, then in step 634 the touch and pen mode is entered or maintained. If in step 628 it is determined that the touch and pen mode is not active or enabled, then in step 638 the data is discarded.

If in step 624 the time condition is not met, then in step 630 it is determined whether a pen then touch mode is active or enabled. If pen then touch mode is active or enabled, then in step 636 pen then touch mode is entered or maintained. If in step 630 it is determined that pen then touch mode is not active or enabled, then in step 630 the data is discarded.

If in step 604 it is determined that the contact point is not associated with the pen contact, then in step 604 it is determined whether a further contact point is detected within a time period T of the first contact point. If no such further contact point is detected within the time period, then in a step 616 it is determined whether touch mode is active or enabled. If touch mode is active or enabled, then in step 618 touch mode is entered or maintained. If in step 616 it is determined that touch mode is not active or enabled, then in step 638 the received board data is discarded.

If in step 608 it is determined that a further contact point has been detected with a time period T of the first contact point, then in step 610 it is determined whether that further contact point is a pen contact point. If it is not a pen contact point, i.e. it is a touch contact point, then the process proceeds to step 616, and step 616 is implemented as described above.

If in step 610 it is determined that the further contact point is a pen contact point, then in step 622 it is determined whether the pen contact point was received within a time period T_{M} of the first contact point.

If the time condition of step 622 is met, then in a step 628 it is determined whether touch and pen mode is active or enabled. If touch and pen mode is active or enabled, then in step 634 touch and pen mode is entered or maintained, otherwise the data is discarded in step 638.

If in step 622 it is determined that the time condition is not met, then in step 626 it is determined whether touch then pen mode is active or enabled. If touch then pen mode is active or enabled, then in step 632 touch then pen mode is entered or maintained. Otherwise in step 638 the data is discarded.

In the example described hereinabove, the time period T is used to define a time period within which two inputs are detected within a sufficient time proximity as to indicate a possible function to be determined by the presence of two contact points. The time period T_{M} is a shorter time period, and is used as a threshold period to determine whether two contact points can be considered to be simultaneous contact points, or one contact point followed by the other, but with both contact points occurring within the time period T.

It should be noted that the process of FIG. 12 is exemplary. The invention is not limited to any details of FIG. 12. The time period T may not be required to implement alternative arrangements, for example.

FIG. 12 thus illustrates an example process flow for determining a mode of input control to be implemented when two contact points are detected at the interactive surface within a time threshold of each other. The process also provides for the detection of the absence of a second contact point within a particular time threshold. In dependence upon an input or a sequence of inputs being detected within the time threshold, a mode of input operation may be entered.

Preferably the mode of input operation dictates an action to be implemented, such as an action to be implemented and associated with a displayed object at which the contact points are detected. In the simplest case, the action responsive to a single contact point may simply be to enable, as appropriate, a touch input or a pen input at the contact point.

Thus the process flow of FIG. 12 may be implemented, in a preferred arrangement, in combination with the process flow of FIGS. 4a and 4b, to determine whether a specific input mode of operation should be implemented responsive to two inputs being detected within a threshold time period on a single object, on a single application window, or on a particular physical area of the interactive surface, or in general at a portion of the interactive surface.

In a specific example of the second preferred arrangement, in dependence upon an input of a first type being detected, an action is implemented to disable detection of input of a second type in an associated region.

The associated region may be a physical region defined in dependence upon the location of the input of the first type on the surface. The associated region may be a physical region around the point of detection of the input of the first type. The associated region may have a predetermined shape and/or a predetermined orientation.

This second preferred arrangement can be further understood with reference to an example. When writing on an interactive display surface using a pen input, it will typically be the case that the hand of the user will come into contact with the interactive display surface. This creates a problem, inasmuch as where the interactive display surface is adapted to detect more than one input type the touch input is detected in combination with the pen input and potentially results in the display of additional inputs on the surface.

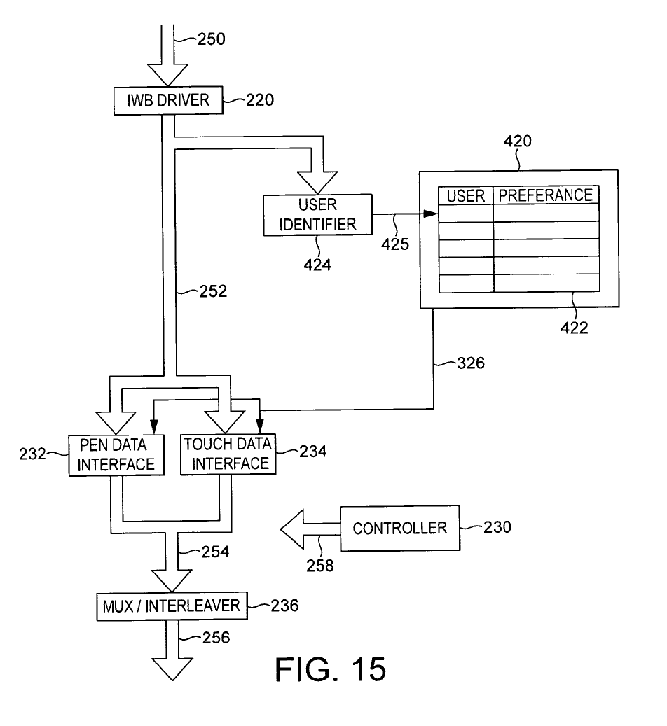

With reference to FIG. 13, there is illustrated the hand 138 holding the pointing device 104, with the pointing device being in contact with the interactive surface 102. In accordance with this specific example of the second preferred arrangement, the interactive display system is adapted such that in writing mode, where the pointing device 104 is being held by the hand 138 for writing on the interactive surface 102, an area around the point of contact 500 of the pointing device 104 is rendered disabled for touch input. Thus as illustrated in FIG. 15, an area 502 is rendered as disabled for touch input. This area 502 may be chosen as an area in which it is expected that a user's hand or forearm will make contact with the interactive surface during a writing or drawing operation, and which surface contact is not to be interpreted as a touch input.

In accordance with the described example of this second preferred arrangement, the interactive display system is thus adapted to automatically ignore any touch inputs within a predefined distance and/or shape from the pen inputs, whilst the pen is on the interactive surface or is in proximity with the interactive surface. Thus, there is provided touch input masking. The touch input masking may apply for a period of time after the pen has been removed from the interactive surface. In this way, a user is able to write on the surface of the interactive display, with their hand in contact with the surface, and only the inputs from the pen will be processed.

The touch input is thus prevented from interfering with the pen input, and affecting the displayed image. The shape of the touch input mask may be predefined, or may be user defined. For example, for a hand or arm input, a touch mask may be defined which extends around and down from the pen point. The touch mask may automatically follow the pen input point, acting as a tracking or dynamic touch input mask.

The touch input mask area 502 may, for example, be a circular area having a fixed or variable radius; an elongated area or complex area (such as a user defined shape); a current surface “quadrant” based upon a current pen position; or a current surface “half” based upon a current pen position.

In an alternative arrangement a mask area for pen inputs may be defined around a touch point.

In accordance with a third preferred arrangement, one or more portions of the display surface may be adapted to be responsive to at least one input of a specific type further in dependence on the identification of a specific user.

For example, a first user may prefer to use the interactive display system with touch inputs, whereas a second user may prefer to use the interactive display system using a pen. The preferences for the respective users may be stored with the interactive display system, together with other user preferences for each user in each user's account.

A user may be identified by the interactive display system in dependence on a user log-in as known in the art. Responsive to the user's log-in, the inputs that the board accepts may be selectively adapted to fit with the user's stored preferences. Thus the user's account includes the input properties for the user, and on log-in by a user those properties are retrieved by the computed and applied.

Alternatively, if a pointing device is associated with a specific user (in accordance with techniques known in the art), then the system may dynamically disable touch input to fit with the user's stored preferences responsive to detection of that particular pen on the interactive display surface.

More generally, responsive to detection of a pointing device which is identifiable as being associated with one or more input properties, those input properties are applied. Thus the pointing device may be identifiable, and associated with a specific user, such that the user input properties are applied. Alternatively the input properties may be associated with the pointing device itself, regardless of any user using the pointing device.

A pointing device may be identifiable, as known in the art, due to it including a resonant circuit having a unique centre frequency. Alternatively a pointing device may include a radio frequency identification (RF ID) tag to uniquely identify it. In other arrangements it may be possible to also identify a user providing a touch input.

In general, therefore, it may be possible to identify the pointer providing an input, or a user associated with a pointer providing the input.

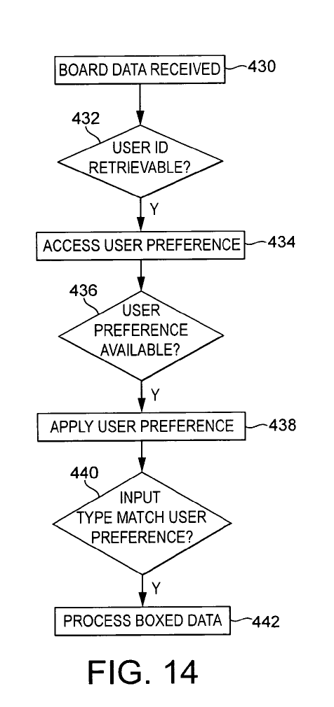

An example implementation in accordance with the third preferred arrangement is now described with reference to the flow process of FIG. 14 and the functional elements of FIG. 15.

With reference to FIG. 14, in a step 430 board data is received at the interactive whiteboard driver 220 on board data bus 250. It should be noted that in FIG. 15 where elements refer to elements shown in previous figures, like reference numerals are used.

The board data on the board data bus 250 is provided by the interactive whiteboard driver 220 on the input data bus 252. A user identifier block 424 receives the board data on the input data bus 252. In a step 432, the user identifier block 424 determines whether a user identity is retrievable. If a user identity is retrievable from the board data, then in a step 434 user preferences, namely input property preferences, are accessed. Thus a signal on line 425 delivers the user identity to a user identity store 420, and a look-up table 422 within the user identity store which stores user identities in combination with user preferences is accessed to determine whether any preference is predefined for the particular user.

It will be understood that the principles of this described arrangement apply also to a pointing device identity, rather than a user identity.

If it is determined in step 436 that a user preference is available, then in a step 438 the user input property preference is applied. This is preferably achieved by setting control signals on lines 326 to the pen data interface 232 and touch data interface 234, to enable or disable such interfaces in accordance with the user input property preferences.

In a step 440 it is determined whether the input type associated with the received board data matches the user input property preferences, i.e. whether the board data is from a touch input or a pen input. This determination is preferably made by simply enabling or disabling the interfaces 232 and 234 which are respectively adapted to process the pen data and touch data such that if one or the other is not enabled the data is not passed through the respective interface.

In accordance with whether the pen data interface and touch data interface 232 and 234 are enabled, the pen data and touch data are then provided on the output interface 254 for delivery to the multiplexer/interleaver 236, before further processing of the board data as denoted by step 442.

Individual pointing device inputs could also be enumerated and identified such that user objects could be tagged with allowable pointing input identifiers. For example, in an arrangement where a yellow object is displayed, the object may be associated with an input property which only accepts inputs from a pointing device, and further only from a pointing device which is identifiable as a yellow pen. A pointing device which comprises a yellow pen is thus the only input which can move such yellow objects. Thus the yellow pen may be associated with a unique resonant frequency, or number encoded in an RF ID tag, which is allocated to a ‘yellow pen’. The controller is then able to retrieve the identifier from the input board data, and compare this to an identifier included in the input properties of a displayed object. In a practical example, an application may display bananas, and the yellow pen may be the only input device which can control the movement or manipulation of the displayed bananas. This principle extends to an object, part of an object, application, or physical area.

Preferably in any arrangement the at least one portion of the display surface is dynamically adapted to be responsive to at least one input of a specific type. Thus, in use, the input type for controlling at least one portion of the interactive display surface may change during the given user session or use of an application. Thus the display surface may be variably adapted to be responsive to at least one input of a specific type over time.

In a fourth preferred arrangement the existence of an interactive display surface which allows for the detection of inputs associated with disparate and independent technologies is utilised to enhance the user input capabilities of a user input device.

This fourth preferred arrangement is described with reference to an example where the first and second types of input technology are electromagnetic grid technology and projected mode capacitance technology (for touch detection).

A physical object housing an electromagnetic means (specifically a coil) such as provided by a prior art pen device interacts with the electromagnetic grid when placed upon the surface. The position of the object on the surface can be accurately and independently determined by the electromagnetic grid technology.

In accordance with this fourth arrangement, there is also provided a conductive portion on the contact face of the physical object that interacts with the interactive display surface, which conductive portion interacts with the projected mode capacitance technology when the object is placed upon the surface. The position of this conductive portion can be accurately and independently determined by the projected mode capacitance technology.

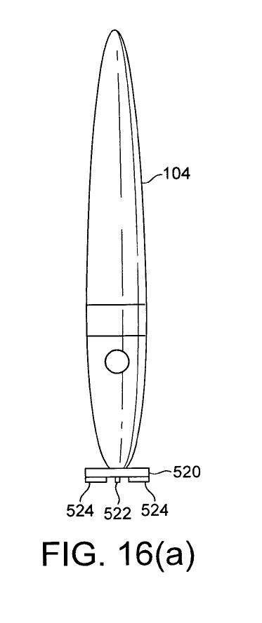

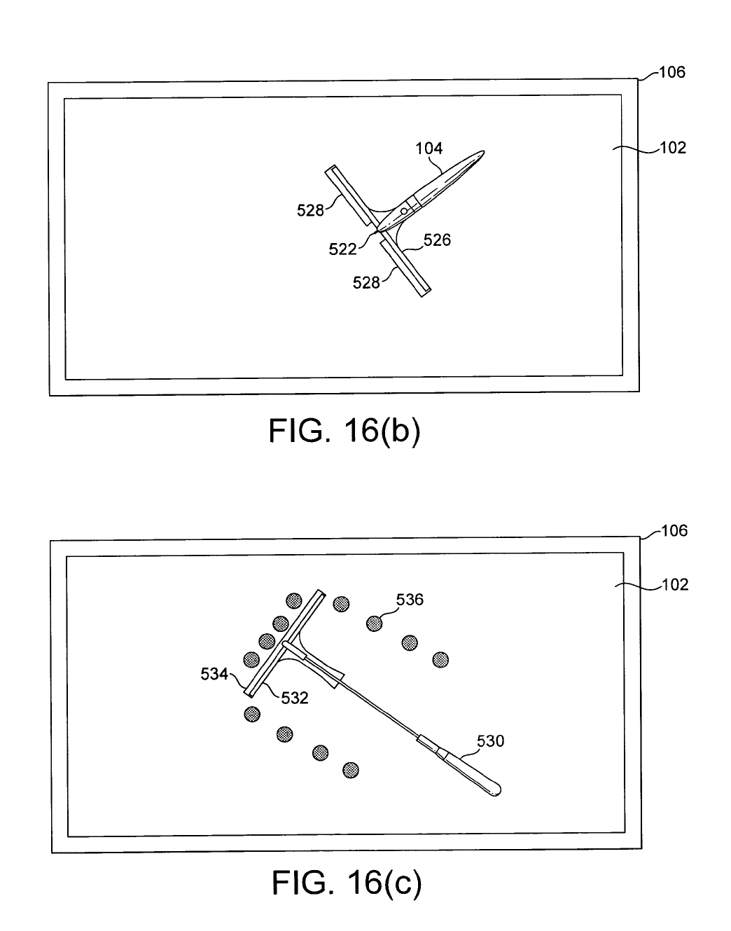

This fourth arrangement is now further described with reference to FIGS. 16a to 16c.

With reference to FIG. 16a, there is illustrated a pointing device 104 which is adapted as known in the art to provide pen inputs at the interactive surface 102. In accordance with this fifth preferred arrangement, the contact point of the pointing device 104 which makes contact with the interactive surface 102 is further adapted. In FIG. 16a reference numeral 522 identifies the point of the pointing device 104, which in effect corresponds to the nib of a pen, which makes contact with the interactive surface 102 for providing pen-type inputs. In accordance with this fifth preferred arrangement, there is also provided an additional conductive area 520 formed around the tip of the pointing device 104, which is provided with one or more conductive areas 524 which additionally contact the interactive surface and simulate touch inputs. In an arrangement the conductive portion 520 may be a circular disk, and the conductive area 524 may be formed around the circumference of the circular disk.

Thus pen-type inputs and touch type inputs can be provided simultaneously from a single input device.

In a particular arrangement the conductive area 520 may form a small bar with conductive surfaces 524 at each end, to allow calligraphic handwriting to be performed at the interactive surface. It should be noted that the conductive portion 520 is not necessarily drawn to scale in FIG. 16a, and may be much smaller relative to the size of the tip of the pointing device 104.

For such an arrangement to work, the tip 522 of the pointing device 104 is permitted direct access to the interactive surface 102 through an opening in the conductive portion 520.

In a particularly preferred example, conductive portion 520 may form a “clip-on” device, such that it can be connected to the pointing device 104 as and when necessary. Further, different shapes and sizes of conducting portions 520 may be clipped onto the pointing device 104 according to different implementations.

A further example in accordance with this principle is illustrated with respect to FIG. 16b.

As can be seen in FIG. 16b, the pointing device 104 is provided with an alternative clip-on conductive portion 526. The conductive portion 526 is the same shape and dimensions of a “squeegee” device, with the pointing device 104 forming a handle of such squeegee device. The pointing tip 522 of the pointing device 104 projects through the centre of the conductive portion 526 to allow contact with the interactive surface 102. Conductive contacts 528 along the length of the conductive portion 526 provide for touch type inputs at the interactive surface. In such an arrangement, the squeegee can be used, for example, for virtual screen clearing/wiping actions, in different widths according to the width of the conductive portion 526. Alternatively, a mode associated with the pointing device 104 may determine the action responsive to the contact portions 528.

A further example is illustrated in FIG. 16c.

In FIG. 16c there is illustrated a pointing device comprising a pointing stick, denoted by reference numeral 530, as known in the art. The pointing stick 530 is adapted to provide for electromagnetic interaction with the interactive surface 102. The pointing stick 530 is adapted to be fitted with a clip-on squeegee-type device comprising a longitudinal body 532 and a conductive portion 534 for contact with the interactive surface 102. In this arrangement the conductive portion 534 may be moved across the interactive surface 102 to push or pull objects on the interactive surface 102, such as displayed objects 536 representing counters or coins, dependent upon the state of a button associated with the pointing device 530.

The input device could take the physical form of a traditional mouse. A point on the surface of the mouse which interacts with the interactive surface may comprise an electromagnetic pen point. An initial conductive area on the surface of the mouse is provided for projected capacitance interaction.

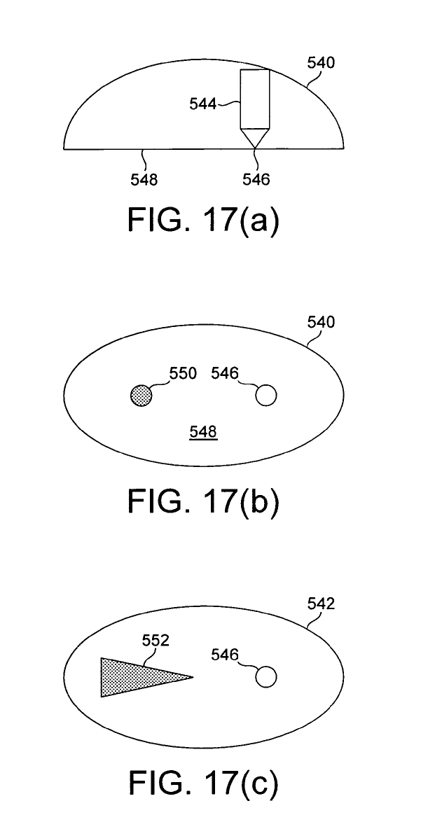

With reference to FIG. 17a to FIG. 17d there is illustrated examples in accordance with the fifth preferred arrangement utilising a conventional mouse housing for providing inputs on an interactive surface.

FIG. 17a illustrates a cross section through the housing 540 of a mouse-type device, and FIG. 17b illustrates the underside of the mouse housing of FIG. 17a.

The mouse housing 540 includes an electromagnetic means 544 equivalent to a pointing device 104, for providing interaction with the electromagnetic circuitry of the interactive surface. The pointing device 544 has a contact point 546 which makes contact with the interactive surface 102. The underside surface 548 of the mouse housing 540 is generally placed on the interactive surface 102.

As can be seen from the view illustrated in FIG. 17b of the underside 548 of the mouse housing 540, there is provided a contact point 546 for the pointing device means. In addition there is provided a further contact point 550, which comprises a conductive area for contact with the interactive surface, for providing a simulated touch input.

As can be seen in FIG. 17b, the conductive portion 550 is circular in shape. In alternative arrangements, such as that illustrated in FIG. 17c, the conductive portion may be provided with a different shape, such as a triangular shape 552 in FIG. 17c. Thus the contact portion may be provided with a particular shape, orientation, or series of shapes, in order to provide a unique identification associated with the touch contact.

The examples described hereinabove offer particularly advantageous implementations, in that there is no requirement to redesign the technology associated with the existing pointing device 104, and that only one electromagnetic coil is required in the input device in order to provide both pen and touch input from a single device.

Thus in accordance with the fifth arrangement as described there is provided a means for combining the input attributes or modes (either permanently or temporarily) from multiple, disparate position sensing technologies and then associating such with one or more computer functions. This arrangement requires the availability of a multi-mode interactive surface, and an input device which combines two types of input technology, preferably electromagnetic technology and projected mode capacitance technology to provide a touch input.

A physical object housing an electromagnetic pen (or electromagnetic technology) interacts with an electromagnetic grid of the interactive surface when placed upon the surface. The position of the pen on the surface can be accurately and independently determined by the electromagnetic grid technology. As there is also provided a conductive area on the contact face of the physical object that interacts with the projected mode capacitance technology when the object is placed upon the interactive surface, the position of this conductive area can also be accurately and independently determined by the projected mode capacitance technology.

Using the above combination of input attributes, the following can be ascertained: i) device ownership (via the electromagnetic pen frequency; or via a unique shape of a conductive area); ii) device position via electromagnetic or projected capacitance; iii) device orientation direction, via the position or relationship between the two points of input (electromagnetic and projected capacitance); or iv) device button status, via electromagnetic pen buttons connected to the outside of the physical object, such as pen buttons.

The same functional objective could be achieved by combining two electromagnetic pens using different frequencies, which could then be used without a touch capacitance surface with a single electromagnetic grid. However the solution described herein offers a number of benefits over such a modification, as it does not require a re-design of current electromagnetic pointing devices, and requires only one electromagnetic coil.

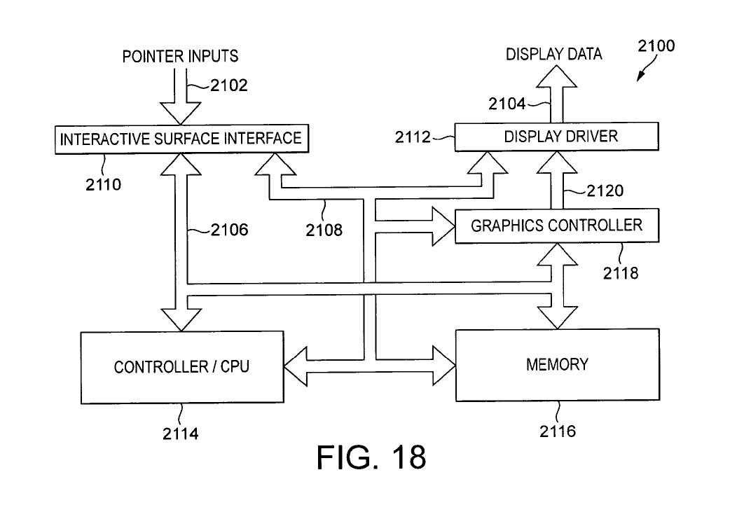

The main function elements for the computer system for implementing the preferred embodiments of the invention is illustrated in FIG. 18. The invention may be implemented in conventional processor based hardware, adapted to provide a necessary functionality to implement preferred embodiments of the invention. FIG. 18 illustrates the main functional elements, and not the complete function elements in order to implement the computer functionality.

The main functional elements 2100 comprise a controller or CPU 2114, a memory 2116, a graphics controller 2118, an interactive surface interface 2110, and a display driver 2112. All of the elements are interconnected by a control bus 2108. A memory bus 2106 interconnects the interactive surface interface 2110, the controller 2114, the memory 2116, and the graphics controller 2118. The graphics controller provides graphics data to the display driver 2112 on a graphics bus 2120.

The interactive surface interface 2110 receives signals on bus 2102, being signals provided by the interactive display surface comprising data from contact points or pointer inputs. The display driver 2112 provides display data on display bus 2104 to display appropriate images to the interactive display surface.

The methods described herein may be implemented on computer software running on a computer system. The invention may therefore be embodied as a computer program code being executed under the control of a processor or a computer system. The computer program code may be stored on a computer program product. A computer program product may be included in a computer memory, a portable disk, or portable storage memory, or hard disk memory.

The invention and its embodiments are described herein in the context of application to an interactive display of an interactive display system. It will be understood by one skilled in the art that the principles of the invention, and its embodiments, are not limited to the specific examples of an interactive display surface set out herein. The principles of the invention and its embodiments may be implemented in any computer system including an interactive display system adapted to receive inputs from its surface via two or more disparate and independent technologies.

In particular, it should be noted that the invention is not limited to the specific example arrangements described herein of a touch-sensitive input technology and an electromagnetic input technology.

The invention has been described herein by way of reference to particular examples and exemplary embodiments. One skilled in the art will appreciate that the invention is not limited to the details of the specific examples and exemplary embodiments set forth. Numerous other embodiments may be envisaged without departing from the scope of the invention, which is defined by the appended claims.

What is claimed is:

1. An interactive display system including a display surface, a first means for detecting a first type of user input at the display surface and a second means for detecting a second type of user input at the display surface, wherein at least one portion of the display surface is adapted to be selectively responsive to an input of a specific type.

2. The interactive display system of claim 1 wherein the at least one portion of the display surface is at least one physical area of the display surface.

3. (canceled)

4. The interactive display system of claim 1 wherein the at least one portion of the display surface is at least one object displayed on the display surface.

5. (canceled)

6. The interactive display system of claim 4 wherein the at least one portion is a part of at least one displayed object.

7. The interactive display system of claim 6 wherein the part of the displayed object is at least one of a centre of an object, an edge of an object, or all the edges of an object.

8. The interactive display system of claim 1 wherein the at least one portion of the display surface is at least one window of at least one application running on the interactive display system.

9. (canceled)

10. The interactive display system of claim 8 wherein the at least one portion is a part of a displayed window of at least one displayed application.

11. The interactive display system of claim 1 in which the at least one portion of the display surface is adapted to be selectively responsive to at least one of: i) a first type of user input only; ii) a second type of user input only; iii) a first type of user input or a second type of user input; iv) a first type of user input and a second type of user input; v) a first type of user input then a second type of user input; vi) a second type of user input then a first type of user input; or vii) no type of user input.

12. The interactive display system of claim 1 wherein the at least one portion of the display surface is adapted to be responsive to an input of a specific type further in dependence upon identification of a specific user.

13. (canceled)

14. The interactive display system of claim 1 wherein the at least one portion of the display surface is dynamically adapted to be responsive to an input of a specific type.

15. (canceled)

16-59. (canceled)

60. A method for detecting inputs in an interactive display system including a display surface, the method comprising detecting a first type of user input at the display surface and detecting a second type of user input at the display surface, the method further comprising selectively responding to an input of a specific type at at least one portion of the display surface.

61. The method of claim 60 wherein the at least one portion of the display surface is at least one physical area of the display surface.

62. (canceled)

63. The method of claim 60 wherein the at least one portion of the display surface is at least one object displayed on the display surface.

64. (canceled)

65. The method of claim 63 wherein the at least one portion is a part of at least one displayed object.

66. The method of claim 65 wherein the part of the displayed object is at least one of a centre of an object, an edge of an object, or all the edges of an object.

67. The method of claim 60 wherein the at least one portion of the display surface is at least one window of at least one application running on the interactive display system.

68. (canceled)

69. The method of claim 67 wherein the at least one portion is a part of a displayed window of at least one displayed application.

70. The method of claim 60 in which the at least one portion of the display surface is selectively responsive to at least one of: i) a first type of user input only; ii) a second type of user input only; iii) a first type of user input or a second type of user input; iv) a first type of user input and a second type of user input; v) a first type of user input then a second type of user input; vi) a second type of user input then a first type of user input; or vii) no type of user input.

71. The method of claim 60 wherein the at least one portion of the display surface is responsive to an input of a specific type further in dependence upon identification of a specific user.

72. (canceled)

73. (canceled)

74. The method of claim 60 wherein the at least one portion of the display surface is variably responsive to an input of a specific type over time.

75-118. (canceled)
